(19) United States
(12) Patent Application Publication
(10) Pub. No.: US 2025/0104349 A1
(43) Pub. Date: Mar. 27, 2025

(54) TEXT TO 3D VIA SPARSE MULTI-VIEW GENERATION AND RECONSTRUCTION

(71) Applicant: ADOBE INC., SAN JOSE, CA (US)

(72) Inventors: Sai Bi, San Jose, CA (US); Jiahao Li, Chicago, IL (US); Hao Tan, Santa Clara, CA (US); Kai Zhang, Sunnyvale, CA (US); Zexiang Xu, San Jose, CA (US); Fujun Luan, Sunnyvale, CA (US); Yinghao Xu, San Jose, CA (US); Yicong Hong, Bruce (AU); Kalyan K. Sunkavalli, Saratoga, CA (US)

(21) Appl. No.: 18/894,176

(22) Filed: Sep. 24, 2024

Related U.S. Application Data
(60) Provisional application No. 63/585,786, filed on Sep. 27, 2023.

(51) Int. Cl. G06T 17/00; G06T 7/73; G06T 15/20

(52) U.S. Cl. CPC G06T 17/00; G06T 7/73; G06T 15/20; G06T 2207/20081

(57) ABSTRACT

A method, apparatus, non-transitory computer readable medium, and system for 3D model generation include obtaining a plurality of input images depicting an object and a set of 3D position embeddings, where each of the plurality of input images depicts the object from a different perspective, encoding the plurality of input images to obtain a plurality of 2D features corresponding to the plurality of input images, respectively, generating 3D features based on the plurality of 2D features and the set of 3D position embeddings, and generating a 3D model of the object based on the 3D features.

### CROSS-REFERENCE TO RELATED APPLICATION

This application claims priority under 35 U.S.C. § 119 to U.S. Provisional Application No. 63/585,786, filed on Sep. 27, 2023, in the United States Patent and Trademark Office, the disclosure of which is incorporated by reference herein in its entirety.

### BACKGROUND

The following relates generally to 3D model generation, and more specifically to 3D model generation using a machine learning model. 3D model generation refers to the use of a computer to create a three-dimensional representation of an object or scene depicted in a set of input images using an algorithm or a processing network. In some cases, 3D model generation software can be used for various tasks, such as 3D reconstruction, object recognition, rendering, and animation. For example, 3D model generation includes the use of a machine learning model to generate a 3D model based on an input.

In some cases, 3D model generation includes the use of a machine learning model to generate a 3D model based on a dataset. For example, the machine learning model is trained to generate the 3D model of an object depicted in a set of input images. In some cases, attributes of the 3D model, such as its shape or texture, can be modified based on a set of parameters or additional inputs.

### SUMMARY

Aspects of the present disclosure provide a method and system for 3D model generation. In one aspect, the system receives a text prompt describing an object and generates a 3D model representing the object in three-dimensional space. According to some aspects, the system includes an image generation model trained to generate a synthetic image based on the text prompt. In one aspect, the synthetic image depicts a plurality of views of the object described by the text prompt. According to some aspects, the system includes a reconstruction model trained to generate triplane features based on the synthetic image. In one aspect, the reconstruction model generates 2D image features based on the synthetic image, where the 2D image features include information about each of the views of the object and a corresponding view angle information for each of the views. The reconstruction model further generates triplane features based on the 2D image features. In some aspects, the system includes a rendering component configured to generate the 3D model based on the triplane features.

Aspects of the present disclosure provide a method and system for 3D model generation. In one aspect, the system receives a set of images depicting an object from different view angles, generates a 3D model based on the set of images, and generates pose information that corresponds to each of the set of images with respect to the 3D model. In some aspects, the system includes a reconstruction model trained to generate triplane components based on a set of input images independent of the view angle information. In some aspects, the reconstruction model includes an image encoder configured to receive view encodings for each of the plurality of input images, where the view encodings provide information on the view angles with reference to the view angle of the first input image among the plurality of input images. The image encoder generates 2D image features based on the input images and the view encodings. In one aspect, the reconstruction is trained to generate triplane features based on the 2D image features. In one aspect, the system includes a rendering component configured to generate the 3D model based on the triplane features. In some aspects, the reconstruction model is trained to generate image-specific output features based on the 2D image features, where the image-specific output features are used to generate pose information for each of the input images with respect to the 3D model.

A method, apparatus, non-transitory computer readable medium, and system for 3D model generation include obtaining a plurality of input images depicting an object and a set of 3D position embeddings, where each of the plurality of input images depicts the object from a different perspective, encoding the plurality of input images to obtain a plurality of 2D features corresponding to the plurality of input images, respectively, generating, using a 2D-to-3D transformer, 3D features based on the plurality of 2D features and the set of 3D position embeddings, and generating a 3D model of the object based on the 3D features.

A method, apparatus, non-transitory computer readable medium, and system for 3D model generation include obtaining a training set including a plurality of training images depicting different views of a scene, initializing a 2D-to-3D transformer, and training, using the training set, the 2D-to-3D transformer to generate 3D features based on based on a plurality of 2D features and a set of 3D position embeddings, where the plurality of 2D features corresponds to a plurality of input images.

An apparatus and system for 3D model generation include at least one processor, at least one memory storing instructions executable by the at least one processor, an image encoder comprising parameters stored in the at least one memory and trained to encode a plurality of input images to obtain a plurality of 2D features corresponding to the plurality of input images depicting an object, respectively, and a 2D-to-3D transformer comprising parameters stored in the at least one memory and trained to generate 3D features based on the plurality of 2D features and a set of 3D position embeddings.

### BRIEF DESCRIPTION OF THE DRAWINGS

FIG. 1 shows an example of a 3D model generation system according to aspects of the present disclosure.

FIG. 2 shows an example of a method for generating a 3D model according to aspects of the present disclosure.

FIG. 3 shows an example of text-to-3D model generation according to aspects of the present disclosure.

FIG. 4 shows an example of image-to-3D model generation according to aspects of the present disclosure.

FIG. 5 shows an example of image-to-3D model generation and pose information generation according to aspects of the present disclosure.

FIG. 6 shows an example of a method for generating a 3D model according to aspects of the present disclosure.

FIG. 7 shows an example of a 3D model generation apparatus according to aspects of the present disclosure.

FIG. 8 shows an example of a text-to-3D model according to aspects of the present disclosure.

FIG. 9 shows an example of a first reconstruction model according to aspects of the present disclosure.

FIG. 10 shows an example of a second reconstruction model according to aspects of the present disclosure.

FIG. 11 shows an example of an image generation model according to aspects of the present disclosure.

FIG. 12 shows an example of a method for training a 2D-to-3D transformer according to aspects of the present disclosure.

FIG. 13 shows an example of a method for fine-tuning a 2D-to-3D transformer according to aspects of the present disclosure.

FIG. 14 shows an example of a computing device according to aspects of the present disclosure.

### DETAILED DESCRIPTION

The following relates to 3D model generation using machine learning. Embodiments of the disclosure relate to a 3D modeling system that can accurately generate 3D models of an object depicted in a set of input images from different view angles. In some embodiments, the system can accurately generate 3D models of an object described by the text prompt. In some embodiments, the system can accurately generate pose information of each of the input images with respect to the generated 3D model. In one aspect, the system includes a reconstruction model trained to generate triplane features of the object comprising information about the object to be modeled on three orthogonal planes. The triplane features are provided to a rendering component to render the 3D model of the object.

According to some embodiments, the system receives the set of input images to respectively generate a set of 2D image features using an image encoder. In some cases, the image encoder receives the corresponding pose information for each of the set of input images to generate the image features. Accordingly, the 2D image features are pose-aware. In some embodiments, the image encoder receives a set of view encodings respectively for the set of input images when the pose information for the set of input images is unknown. For example, the view encodings ensure that the system can generate pose information using the first image as a reference and the remaining images as the source relative to the first image. Accordingly, the 2D image features include relative pose (e.g., the position and the orientation) information of the object depicted in the set of input images.

According to some embodiments, the system includes a 2D-to-3D transformer trained to generate 3D features based on the 2D image features. In one aspect, the 3D features include combined information from the 2D features that represent the object in 3D space. For example, the 3D features include information such as 3D coordinate information of the object depicted in the input images, depth information, surface normal, pose information (or relative pose information), texture, lighting, and shading. In some embodiments, the reconstruction model generates the triplane features based on the 2D features.

According to some embodiments, the reconstruction model is trained to generate image-specific output features including predicted pose information for each of the input images. In one aspect, the system includes a pose model configured to generate pose information based on the image-specific output features. In some cases, the reconstruction model predicts the pose information for all source images relative to a reference image among the input images with respect to the 3D model.

According to embodiments of the present disclosure, a method, apparatus, and system includes generating high-quality and diverse 3D models conditioned on text or images in a feed-forward manner. According to some embodiments, a two-stage paradigm is used to generate 3D models including a sparse-view generation stage and a sparse reconstruction stage. During the first stage, the system fine-tunes a text-to-image generation model to generate consistent multi-view images of an object based on the input text prompt. In some cases, the machine learning model uses multi-view renderings of 3D objects to finetune the image generation model. In some embodiments, the machine learning model generates a sparse set of 4-view images in the form of a 2 by 2 grid in a single image. Accordingly, multi-view images are generated to attend to each other during the generation which leads to more consistent results. During the second stage, a scalable transformer-based model (e.g., the 2D-to-3D transformer) is trained to predict a 3D model from the generated image. In some cases, the model is trained on multi-view rendered images. For example, the 2D-to-3D transformer takes four-view images as input and generates triplane features by minimizing the reconstruction loss between the renderings at novel views and the ground truth images. Accordingly, the machine learning model can robustly infer the correct geometry and appearance of the object from a set of 4 images (or 4 different views of an object).

According to some embodiments, the machine learning model includes a feed-forward architecture that can generate images based on a text prompt without using large computational resources compared to conventional techniques. According to some embodiments, the machine learning model supports image-conditioned 3D generation by fixing one of the input views during the first stage, which provides fine-grained control over the generated 3D model. Embodiments of the present disclosure include generating high-quality and diverse 3D models conditioned based on text or images in a feed-forward manner, generating sparse, view-consistent images based on a text prompt or an image prompt by fine-tuning the image generation model on 3D data, and generating high-quality 3D models from sparse multi-view images using a feed-forward sparse-view reconstruction model (e.g., the 2D-to-3D transformer).

In some cases, the 2D-to-3D transformer of the disclosure adopts a highly scalable transformer-based architecture and is trained on large-scale 3D data. Accordingly, the machine learning model of the disclosure is able to accurately reconstruct the 3D models of novel unseen objects from a sparse set of 4 images independent of the per-scene optimization.

In the field of 3D modeling, three-dimensional (3D) reconstruction represents a notable challenge in computer vision, with numerous potential applications spanning virtual reality, autonomous navigation, and even medical imaging. Conventional photogrammetry methods and modern neural rendering methods have made tremendous progress in reconstructing high-fidelity geometry and photo-realistic appearances when provided with dense input images. These conventional methods primarily employ a Structure-from-Motion (SfM) solver to estimate camera poses, immediately followed by a dense reconstruction process using either Multi-view Stereo (MVS) or Neural Radiance Fields (NeRF).

Embodiments of the present disclosure provide a system and method that is able to generate a 3D model of the object and relative pose information of each of the input images where the available input images are sparse and from drastically disparate viewpoints. Under conventional circumstances, SfM solvers become highly unreliable and tend to fail most of the time, preventing the subsequent usage of MVS or NeRF methods. However, the ability to reconstruct 3D models from sparse inputs remains relevant and valuable due to the significant reductions in data acquisition costs and processing times, compared to dense-view scenarios. Moreover, it enables applications such as converting sparse product images from e-commerce websites into high-quality 3D assets for interactive display. The implementation of reconstructors for sparse and unposed images has the potential to greatly enhance the accessibility and availability of 3D content creation technologies.

Despite the significant advancements in the field of sparse-view reconstruction, the majority of existing methods require accurate pose information for each of the input images, often requiring dense input images to reliably estimate these parameters. Such dense image captures not only add an additional burden to users but also lead to increased time invested in Structure-from-Motion procedures to obtain the necessary view parameters (e.g., camera parameters). Furthermore, while recent learning-based pose regression methods can estimate camera poses without a 3D reconstruction, the methods tend to deliver sub-optimal results due to a lack of strong shape priors, which offer critical regularization and cues over camera registration.

In some cases, for example, multi-view 3D reconstruction has been a persistent challenge over recent decades. For a faithful reconstruction of 3D objects or scenes, accurate camera poses are essential, often necessitating the resolution of the Structure-from-Motion (SfM) problem. Conventional methods estimate camera poses by establishing correspondences between image pixels or patches. Consequently, the conventional methods demand a dense collection of images and texture-rich regions for reliable feature matching. However, when input views are sparse, these methods and systems frequently struggle to determine accurate camera poses. For example, learning-based feature extraction methods along with feature matching techniques may have enhanced robustness by learning high-level features and correspondences from data. However, performance still degrades in settings with sparse views.

Conventional methods have sought to address the aforementioned issue by directly regressing camera poses through network predictions. Notably, these methods do not incorporate 3D shape information during the camera pose prediction process, and as a result, might not effectively enable neural networks to learn 3D shapes. In some cases, pose estimation and 3D reconstruction are deeply intertwined. Given the intricate relationship between pose estimation and 3D reconstruction, such ad-hoc designs without shape inference can result in imprecise pose estimations that lead to suboptimal results for subsequent reconstruction tasks.

Joint pose estimation and 3D reconstruction form a prevalent principle, enhancing performance in both tasks. This principle is evident in both conventional MVS methods and the neural differentiable rendering methods. However, these methods typically assume that an initial prediction of camera poses is available, usually sourced from the upstream structure-from-motion technique. When the initial camera poses significantly deviate from the ground-truth poses, the joint pose estimation and 3D reconstruction may yield unsatisfactory results. Some systems implement a two-stage prediction process, initially inferring coarse camera poses from neural networks and then refining these predictions. However, embodiments of the present disclosure employ a single-stage inference process, for example, by processing both camera poses and NeRF reconstructions within one neural network evaluation. Accordingly, embodiments of the disclosure are more streamlined than the two-stage process. Moreover, experiments based on embodiments of the present disclosure demonstrate that, even without explicitly constructing connections between camera pose estimation and NeRF reconstruction, the joint learning approach intrinsically grasps the relationships between these two tasks, enhancing individual performances.

In some cases, the NeRF technique necessitates dozens or even hundreds of images to accurately reconstruct a scene. As a result, few-shot NeRF reconstruction is used by employing either regularization strategies or learning priors from extensive datasets. These techniques demand precise camera poses for every input image. However, determining camera positions proves challenging in such sparse-view contexts. In contrast, embodiments of the present disclosure is able to efficiently reconstruct the neural radiance field from sparse views independent of additional camera pose data.

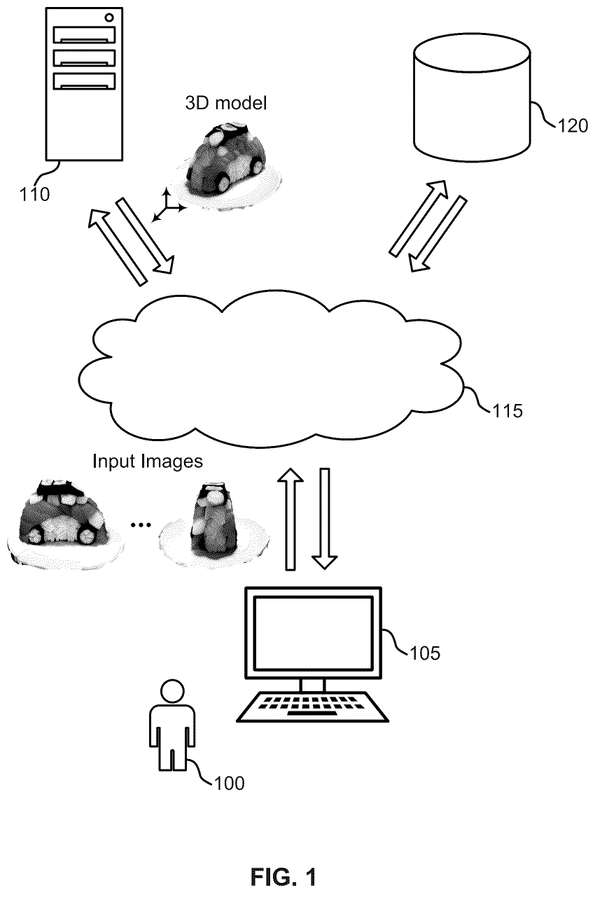

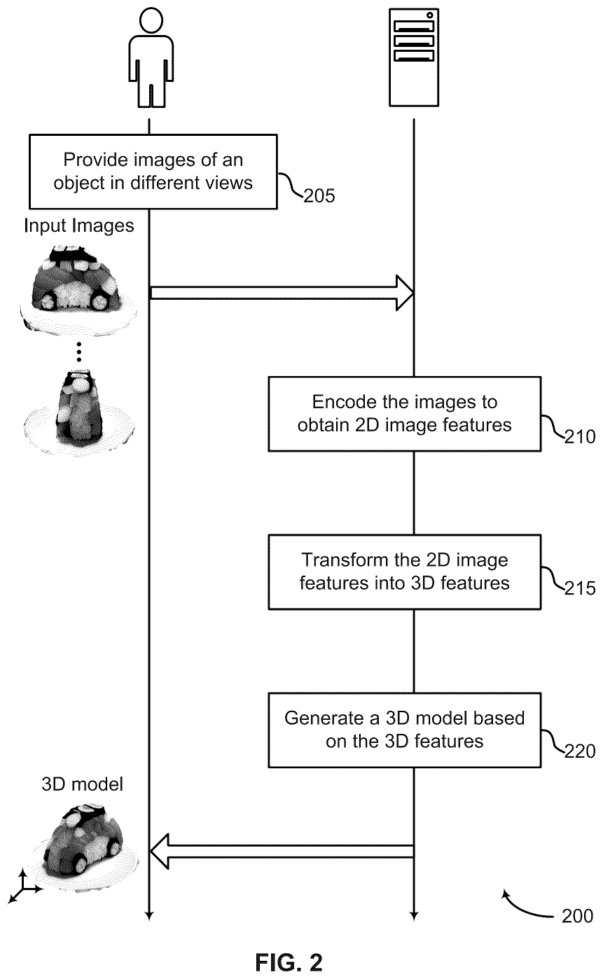

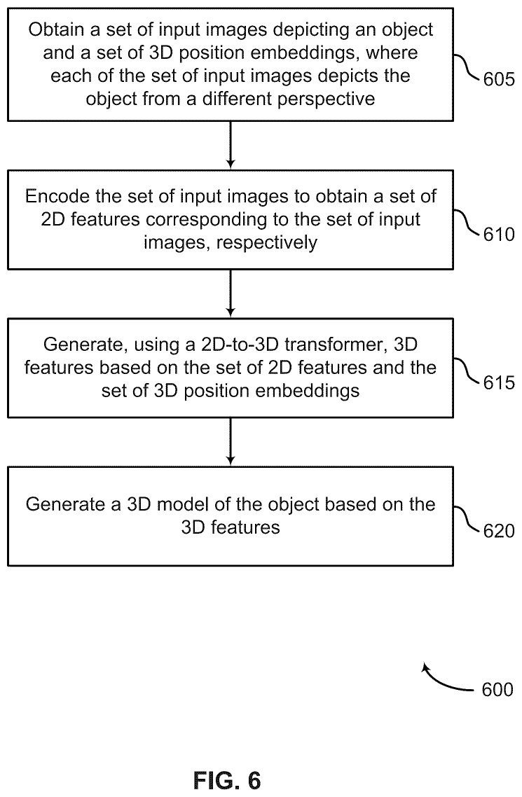

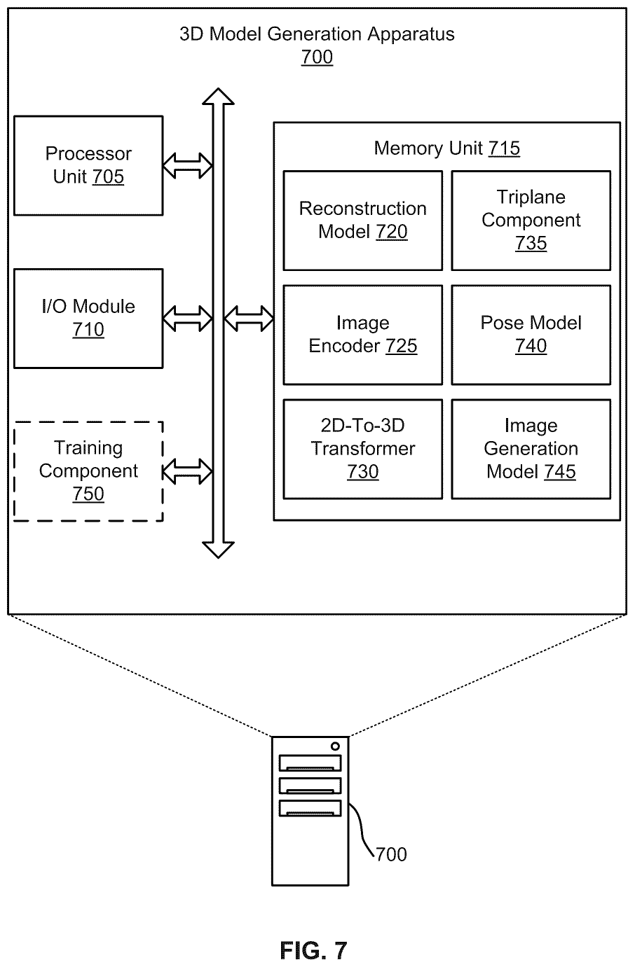

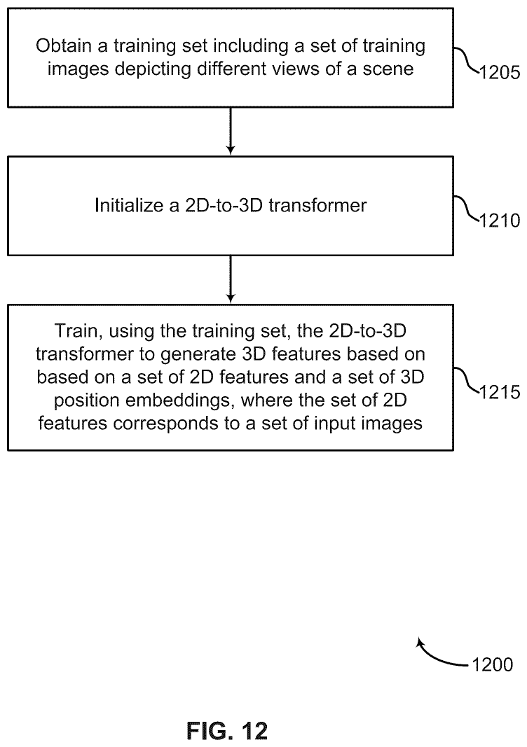

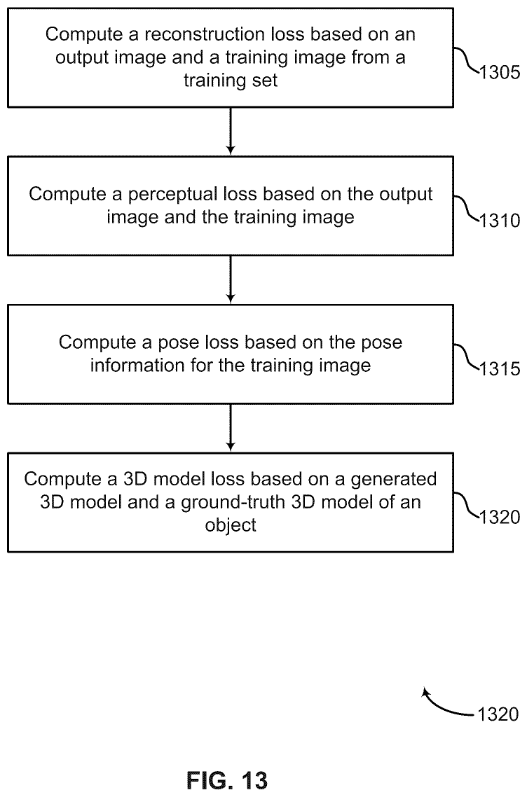

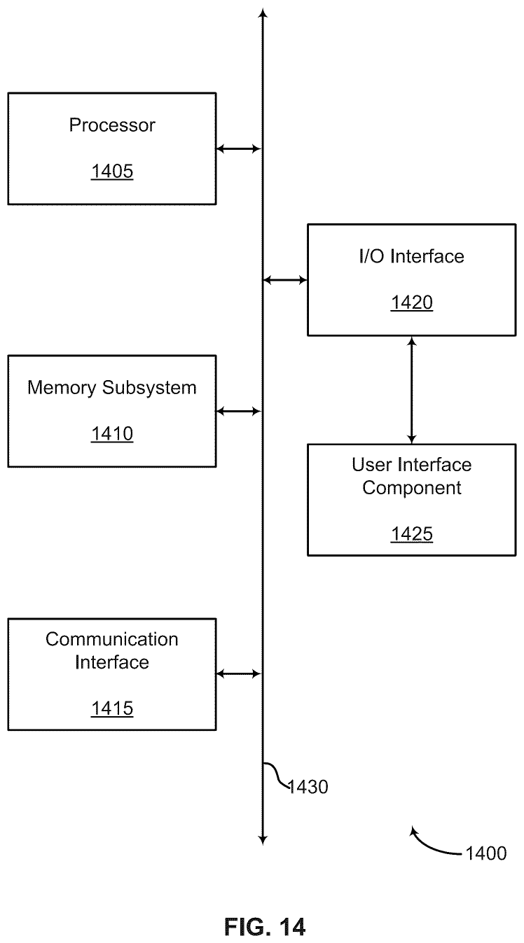

An example system of the inventive concept in image processing is provided with reference to FIGS. 1 and 14. Example applications of the inventive concept in image processing are provided with reference to FIGS. 2-5. Details regarding the architecture of an image processing apparatus are provided with reference to FIGS. 7-11. An example of a process for image processing is provided with reference to FIG. 6. A description of an example training process is provided with reference to FIGS. 12-13.

Accordingly, the present disclosure provides a system and method that improve on conventional 3D model generation systems by generating 3D models more accurately based on a plurality of input images each depicting a view of an object. For example, the system includes an image generation model trained to generate consistent multi-views of the object in a single image. By using the generated image to generate the 3D model, a reconstruction model can robustly infer the correct geometry and appearance of the object from the generated image. According to some embodiments, when a plurality of input images having unknown pose information is provided to the system, by providing corresponding view encodings with the respective input images to the system, the image encoder is able to accurately generate image features including relative pose information of the object depicted in the set of input images. The image features are provided to the reconstruction model to ensure that the 3D model is accurately generated.

### 3D Model Generation

In FIGS. 1-6, a method, apparatus, non-transitory computer readable medium, and system for 3D model generation include obtaining a plurality of input images depicting an object and a set of 3D position embeddings, where each of the plurality of input images depicts the object from a different perspective, encoding the plurality of input images to obtain a plurality of 2D features corresponding to the plurality of input images, respectively, generating, using a 2D-to-3D transformer, 3D features based on the plurality of 2D features and the set of 3D position embeddings, and generating a 3D model of the object based on the 3D features.

Some examples of the method, apparatus, non-transitory computer readable medium, and system further include performing an attention mechanism on the plurality of 2D features and the set of 3D position embeddings. Some examples of the method, apparatus, non-transitory computer readable medium, and system further include generating triplane features based on the 3D features, where the 3D model is generated based on the triplane features.

Some examples of the method, apparatus, non-transitory computer readable medium, and system further include generating an output image based on the 3D model, where the output image depicts the object from a perspective different from the plurality of input images. Some examples of the method, apparatus, non-transitory computer readable medium, and system further include obtaining view information for each of the plurality of input images, where the plurality of input images are encoded based on the view information. Some examples of the method, apparatus, non-transitory computer readable medium, and system further include obtaining an input prompt describing the object. Some examples further include generating the plurality of input images based on the input prompt.

Some examples of the method, apparatus, non-transitory computer readable medium, and system further include obtaining a reference view encoding for a first image of the plurality of input images and a source view encoding for a second image of the plurality of input images, where the first image is encoded based on the reference view encoding and the second image is encoded based on the source view encoding. Some examples of the method, apparatus, non-transitory computer readable medium, and system further include obtaining view intrinsic parameters of each of the plurality of input images, where the plurality of input images are encoded based on the view intrinsic parameters.

Some examples of the method, apparatus, non-transitory computer readable medium, and system further include generating, using the 2D-to-3D transformer, a plurality of image-specific output features corresponding to the plurality of input images, respectively. Some examples further include generating pose information for each of the plurality of input images based on the plurality of image-specific output features. In some aspects, the 2D-to-3D transformer is trained using a training set that includes a plurality of training images depicting different views of a scene.

FIG. 1 shows an example of a 3D model generation system according to aspects of the present disclosure. The example shown includes user 100, user device 105, 3D model generation apparatus 110, cloud 115, and database 120. 3D model generation apparatus 110 is an example of, or includes aspects of, the corresponding element described with reference to FIG. 7.

Referring to FIG. 1, user 100 provides a set of input images to 3D model generation apparatus 110 via user device 105 and cloud 115 to generate a 3D model of the object depicted in the set of input images. In some cases, the input images depicts the object in different view angles. For example, the set of input images shows a sushi car in a side view and a front view. In some embodiments, the set of input images is generated based on a text prompt that states “sushi car” using an image generation model. The image generation model is trained to generate four images in a 2×2 grid, where each of the four images depicts the object described by the text prompt (e.g., the sushi car) in the front view, left-side view, rear view, and right-side view, respectively.

In some aspects, 3D model generation apparatus 110 includes an image encoder configured to encode the set of input images to obtain a set of 2D features each corresponding to each of the set of input images. In some aspects, 3D model generation apparatus 110 further includes a 2D-to-3D transformer trained to generate a 3D feature based on the set of 2D features. Then, a 3D model of the object depicted in the set of input images (e.g., the sushi car) is generated based on the 3D feature. In some cases, an output image of the 3D model is displayed to user 100 via a display screen on user device 105. In some cases, a 360-degree video of the 3D model is displayed to user 100 via the display screen on user device 105.

According to some embodiments, the set of input images shows a sushi car in arbitrary view angles. Then, the image encoder is configured to encode the set of input images to obtain a set of 2D features each corresponding to each of the set of input images. In some cases, the 2D-to-3D transformer is trained to generate a 3D feature based on the set of 2D features. Then, a 3D model of the object depicted in the set of input images (e.g., the sushi car) is generated based on the 3D feature. In addition, 3D model generation apparatus 110 includes a pose model configured to generate pose information of each of the set of input images. For example, the pose information includes the view angles of each input image relative to the first image in the set of input images. In some cases, a perspective view of the output image depicting the sushi car is generated and displayed to user 100 via the display screen on user device 105.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of 3D model generation apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the 3D model generation apparatus 110 is further described with reference to FIG. 2.

3D model generation apparatus 110 is an example of, or includes aspects of, the corresponding element described with reference to FIG. 7. According to some aspects, 3D model generation apparatus 110 includes a computer implemented network comprising a machine learning model, a reconstruction model, an image encoder, a 2D-to-3D transformer, a triplane component, a pose model, and an image generation model. In some embodiments, 3D model generation apparatus 110 includes a training component. 3D model generation apparatus 110 further includes a processor unit, a memory unit, and an I/O module. In some embodiments, 3D model generation apparatus 110 further includes a communication interface, user interface components, and a bus as described with reference to FIG. 14. Additionally or alternatively, 3D model generation apparatus 110 communicates with user device 105 and database 120 via cloud 115. Further detail regarding the operation of 3D model generation apparatus 110 is described with reference to FIG. 2.

In some cases, 3D model generation apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data including a plurality of training images depicting different views of a scene. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for generating a 3D model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user (e.g., the user described with reference to FIG. 1) provides a plurality of input images each depicting an object from a different perspective to the 3D model generation apparatus (e.g., 3D model generation apparatus described with reference to FIGS. 1 and 7) to generate a 3D model depicting the object. In some cases, for example, the plurality of input images depicts a sushi car in different view angles. For example, the set of input images shows a sushi car in a left-side view and a front view. In some embodiments, an image generation model generates the plurality of input images based on an input text prompt that states “sushi car”. In some aspects, an image encoder is configured to encode the plurality of input images to obtain a set of 2D features each corresponding to each of the set of input images. Then, a 2D-to-3D transformer is trained to generate a 3D feature based on the set of 2D features. A triplane component is configured to generate a triplane feature based on the 3D feature. Finally, a rendering component renders a 3D model the sushi car based on the triplane feature.

According to some embodiments, the plurality of input images shows a sushi car in arbitrary view angles. Then, the image encoder is configured to encode each of the plurality of input images to obtain corresponding 2D features. Then, a 2D-to-3D transformer is trained to generate a 3D feature based on the 2D features. A triplane component is configured to generate a triplane feature based on the 3D feature. Finally, a rendering component renders a 3D model (or an image representing the 3D model) of the sushi car based on the triplane feature. In some cases, a pose model is configured to generate pose information for each of the plurality of input images. For example, the pose information includes view angles of each input image relative to the first image in the plurality of input images. In some cases, a perspective view of the output image depicting the sushi car is generated and displayed to user 100 via the display screen on user device 105.

At operation 205, the system provides input images of an object in different views. In some cases, the operations of this step refer to, or may be performed by, a user as described with reference to FIG. 1. In some cases, for example, the user provides a text prompt describing an object to an image generation model. Then, the image generation model generates the input images depicting the same object in different views. For example, the image generation model may generate four images depicting the sushi car in front view, right-side view, rear view, and left-side view. In some cases, a set of input images each depicting the object in an arbitrary view angle is provided to the system.

At operation 210, the system encodes the images to obtain 2D image features. In some cases, the operations of this step refer to, or may be performed by, a 3D model generation apparatus as described with reference to FIGS. 1 and 7. In some cases, the operations of this step refer to, or may be performed by, an image encoder as described with reference to FIGS. 7, and 9-11. In some cases, the image encoder encodes each of the input images to obtain 2D image features, respectively. In some cases, each of the 2D image features includes visual information and known pose information of each of the input images. For example, for the input image depicting the sushi car in the front view, the 2D image feature may include visual information of the input image at a view angle of 0 degrees. For example, for the input image depicting the sushi car in the rearview, the pose information may include visual information of the input image at a view angle of 180 degrees.

In some embodiments, when the input images depict the object in arbitrary view angles, the first image feature of the first input image among the input images includes visual information of the first input image having a reference view angle (e.g., an angle between 0 degrees to 360 degrees, inclusive). Then, the second image feature of the second input image among the input images includes visual information of the second input image at a view angle relative to the reference view angle.

At operation 215, the system transforms the 2D image features into 3D features. In some cases, the operations of this step refer to, or may be performed by, a 3D model generation apparatus as described with reference to FIGS. 1 and 7. In some cases, the operations of this step refer to, or may be performed by, a 2D-to-3D transformer as described with reference to FIGS. 7, 9, and 10. In some cases, for example, the 2D-to-3D transformer combines the 2D image features of the plurality of input images to generate a 3D feature representing a 3-dimensional version of the object depicted in the plurality of input images. Having the corresponding view angle information of each input image, the 2D-to-3D transformer is able to accurately construct a 3D feature using the 2D image features. According to some aspects, the 2D image features capture visual information about the spatial relationships within a single image, whereas the 3D feature represents the object in a 3-dimensional space represented in spatial coordinates (x, y, z) in addition to other visual information such as colors, textures, etc.

At operation 220, the system generates a 3D model based on the 3D features. In some cases, the operations of this step refer to, or may be performed by, a 3D model generation apparatus as described with reference to FIGS. 1 and 7. In some cases, the operations of this step refer to, or may be performed by, a reconstruction model as described with reference to FIGS. 7-10. In some cases, a triplane component is configured to convert the 3D feature to a triplane feature. Then, a rendering component is configured to generate the 3D model based on the triplane feature. For example, the 3D model depicts the object described by the text prompt.

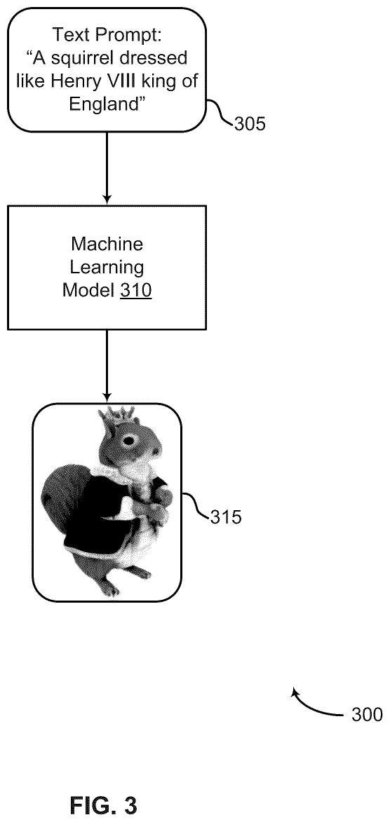

FIG. 3 shows an example of text-to-3D model generation according to aspects of the present disclosure. The example shown includes 3D model system 300, text prompt 305, machine learning model 310, and 3D model 315. In some cases, for example, 3D model system 300 is implemented in a user interface.

Referring to FIG. 3, machine learning model 310 receives text prompt 305 to generate 3D model 315. For example, the text prompt 305 states “a squirrel dressed like Henry VIII king of England”. In some embodiments, an image generation model is configured to generate a plurality of images depicting the object described by the text prompt 305 in different view angles. For example, an image generation model generates four images depicting the squirrel dressed like the king of England. In some cases, the four images depict the object described by the text prompt 305 (e.g., the squirrel) in a front view, a left-side view, a back view, and a right-side view, respectively corresponding to 0° (or) 360°, 90°, 180°, 270°.

In some embodiments, the image generation model is configured to generate images of a top view and a bottom view of the object described by the text prompt 305. In some embodiments, the angle of each of the views is represented in a 3D coordinate system, where the angles are represented in terms of rotations around the principal axes (X, Y, Z). For example, the front view of the object may be represented as (0°, 0°,) 0°, the left-side view of the object may be represented as (0°,−90°,) 0°, and the top view of the object may be represented as (90°, 0°,) 0°. In some embodiments, each of the plurality of images may depict the object in an angle in the 3D space. For example, an image may depict the object in a view having (12°, 75°, 29°).

In some embodiments, the machine learning model 310 generates 2D image features based on the plurality of images. For example, each of the 2D image features include visual information about the corresponding image and the corresponding view information. Then, the machine learning model 310 generates 3D features based on the 2D features. For example, the 3D features include visual information of the 3D model 315 of the object. In some embodiments, the machine learning model 310 generates 3D model 315 based on the 3D features.

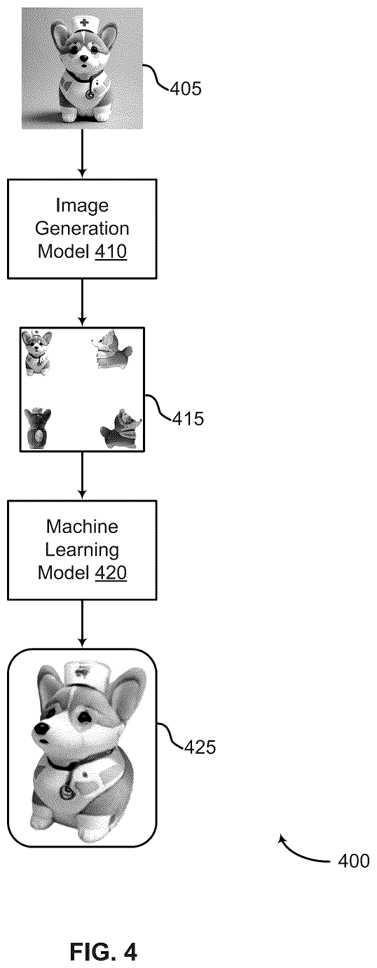

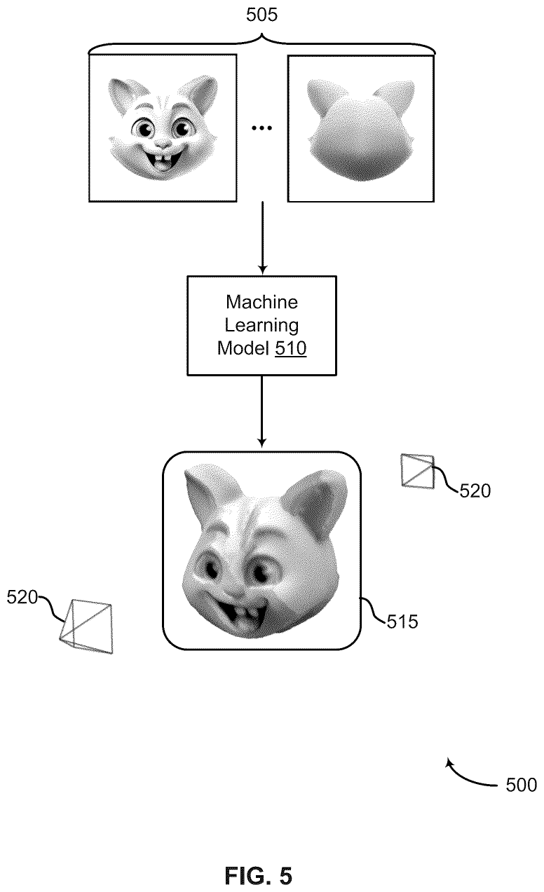

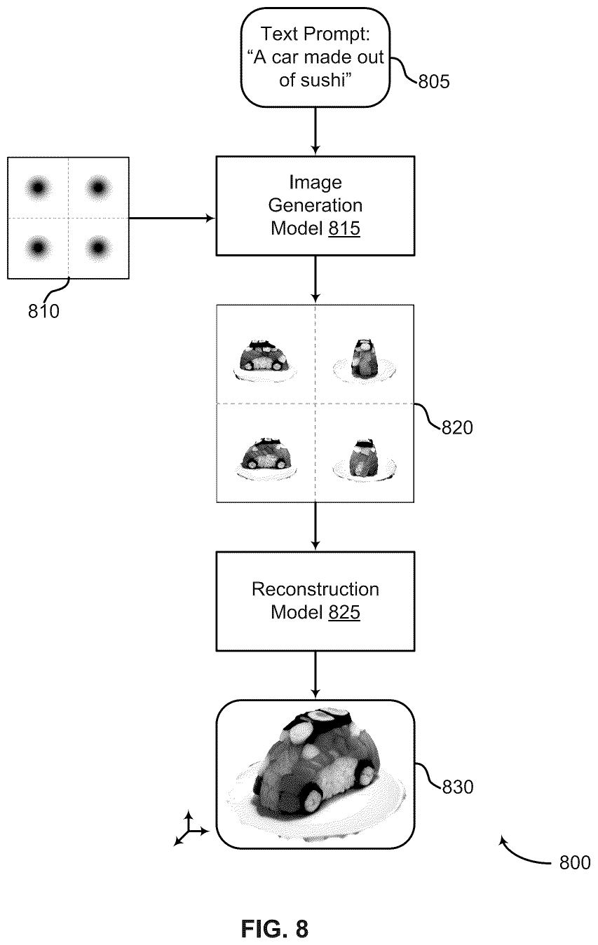

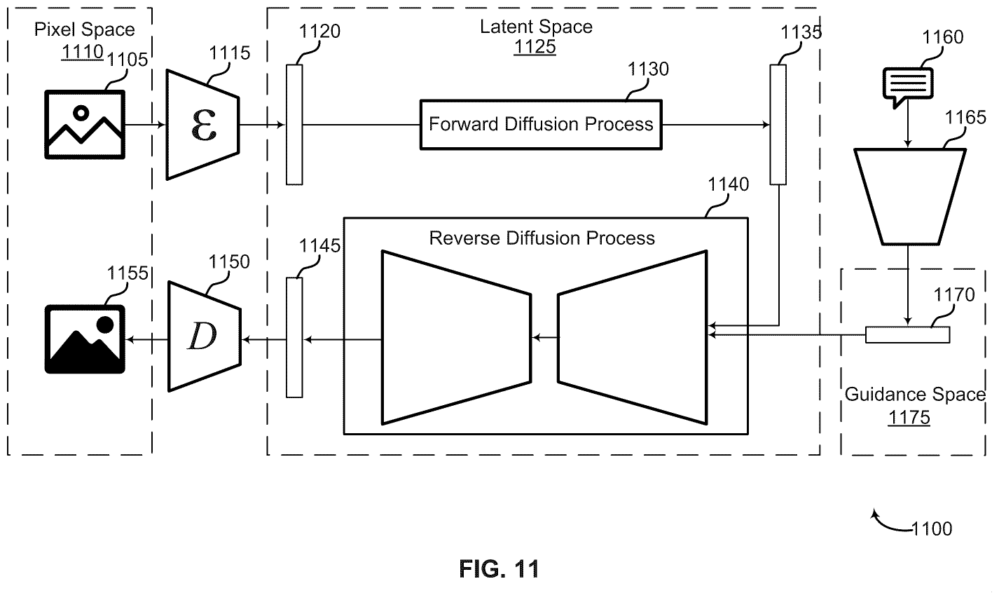

3D model system 300 is an example of, or includes aspects of, the corresponding element described with reference to FIGS. 4 and 5. Text prompt 305 is an example of, or includes aspects of, the corresponding element described with reference to FIGS. 8 and 11. Machine learning model 310 is an example of, or includes aspects of, the corresponding element described with reference to FIGS. 4, 5, and 8. 3D model 315 is an example of, or includes aspects of, the corresponding element described with reference to FIGS. 4, 5, and 8-10.

FIG. 4 shows an example of image-to-3D model generation according to aspects of the present disclosure. The example shown includes 3D model system 400, input image 405, image generation model 410, synthetic image 415, machine learning model 420, and 3D model 425.

Referring to FIG. 4, 3D model system 400 receives input image 405 and generates 3D model 425. In some embodiments, a text prompt describing the input image 405 and the input image 405 are provided to the 3D model system 400. For example, the text prompt may state “A stuffed corgi dressed like a doctor”. In some embodiments, the image generation model 410 is trained to generate a plurality of views depicting the stuffed corgi depicted in the input image 405 in the synthetic image 415. For example, the image generation model 410 generates four views of the stuffed corgi depicted in the input image 405 and combines the four views into a 2×2 grid in the synthetic image 415. In some cases, the four views depict the stuffed corgi in a front view, a left-side view, a back view, and a right-side view, respectively corresponding to 0° (or) 360°, 90°, 180°, 270°.

Then, the machine learning model 420 takes the synthetic image 415 and generates the 3D model 425 representing the stuffed corgi. For example, the machine learning model 420 generates 2D features based on the synthetic image 415, where each of the 2D features represents a view of the stuffed corgi depicted in the synthetic image 415. In some embodiments, the machine learning model 420 generates 3D features based on the 2D features. In some embodiments, the machine learning model 420 generates the 3D model 425 depicting the stuffed corgi based on the 3D features.

During training, at each of the sampling timestep (e.g., the reverse diffusion process described with reference to FIG. 11), the latent of the input image 405 (located in the top-left quadrant of the synthetic image) is maintained and the image generation model 410 adds noise to the latent of the remaining three views of the object (e.g., the stuffed corgi). In some cases, the image generation model 410 generates the view depicted in the input image 405 and the remaining three views in the synthetic image 415. Accordingly, the image generation model 410 can generate other views of the object while accounting for the conditioning image.

3D model system 400 is an example of, or includes aspects of, the corresponding element described with reference to FIGS. 3 and 5. Image generation model 410 is an example of, or includes aspects of, the corresponding element described with reference to FIGS. 7 and 8. Synthetic image 415 is an example of, or includes aspects of, the corresponding element described with reference to FIG. 8.

Machine learning model 420 is an example of, or includes aspects of, the corresponding element described with reference to FIGS. 3, 5, and 8. 3D model 425 is an example of, or includes aspects of, the corresponding element described with reference to FIGS. 3, 5, and 8-10.

FIG. 5 shows an example of image-to-3D model generation and pose information 520 generation according to aspects of the present disclosure. The example shown includes 3D model system 500, input views 505, machine learning model 510, 3D model 515, and pose information 520.

Referring to FIG. 5, machine learning model 510 receives input views 505 and generates 3D model 515 and pose information 520 corresponding to each image of the input views 505. In some cases, each of the input views 505 depicts an object (e.g., a toy bulldozer made of building blocks) from a different arbitrary view angle. In some cases, the arbitrary view angles are unknown. The machine learning model 510 encodes each of the input views 505 into a 2D feature. For example, the 2D feature includes visual information about each of the input views 505 and the view angle information with respect to the view angle of the first input image among the input views 505. Then, the machine learning model 510 generates 3D features based on a plurality of 2D features corresponding to the input views 505. The machine learning model 510 generates 3D model 515 representing the toy bulldozer depicted in the input views 505.

According to some embodiments, the machine learning model 510 generates image-specific output features each corresponding to each of the input views 505. In some cases, the machine learning model generates pose information 520 that represents a view angle of each of the input views 505 with respect to the 3D model 515. For example, two pyramidal indicators representing the pose information 520 may be disposed at locations corresponding to the view angle of each of the input views 505. For example, the pose information 520 includes the orientation and position of each of the input views 505 relative to the 3D model 515. In some cases, the pose information 520 indicate the specific view angles or perspectives from which the 3D model 515 is being observed. In some embodiments, the machine learning model 510 may output the pose information 520 in the form of coordinate systems.

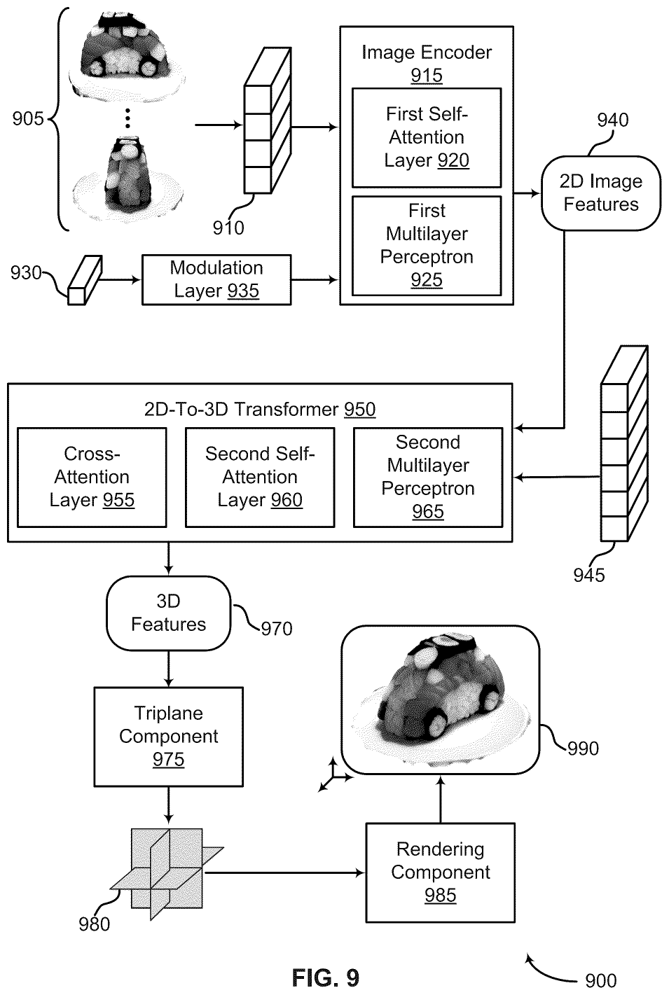

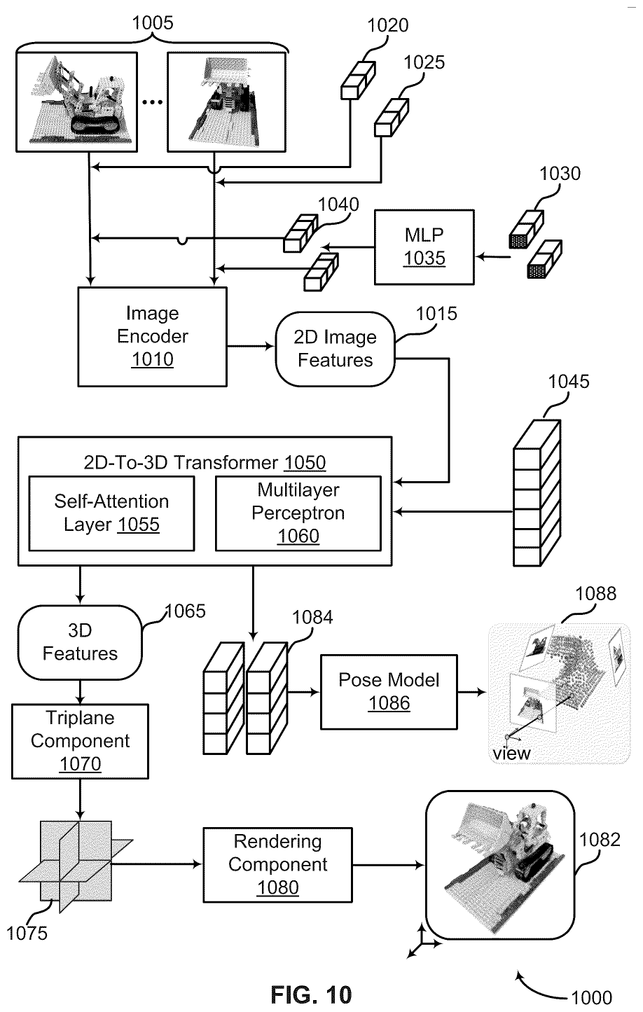

3D model system 500 is an example of, or includes aspects of, the corresponding element described with reference to FIGS. 3 and 4. Input views 505 is an example of, or includes aspects of, the corresponding element described with reference to FIGS. 9 and 10. Machine learning model 510 is an example of, or includes aspects of, the corresponding element described with reference to FIGS. 3, 4, and 8.

3D model 515 is an example of, or includes aspects of, the corresponding element described with reference to FIGS. 3, 4, and 8-10. Pose information 520 is an example of, or includes aspects of, the corresponding element described with reference to FIG. 10.

FIG. 6 shows an example of a method 600 for generating a 3D model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains a set of input images depicting an object and a set of 3D position embeddings, where each of the set of input images depicts the object from a different perspective. In some cases, the operations of this step refer to, or may be performed by, a reconstruction model as described with reference to FIGS. 7-10. In some cases, for example, the plurality of input images are combined into a single image separated by quadrants, where each of the quadrants include a corresponding input image from the plurality of input images. In some cases, for example, the object may be depicted in a front view, a left-side view, a back view, and a right-side view, respectively corresponding to 0° (or) 360°, 90°, 180°, 270°. In some cases, the object may be depicted in an arbitrary view angle such as 37°. In some cases, the perspective of the object may be represented in a 3D coordinate system, where the angles are represented in terms of rotations around the principal axes (X, Y, Z). In some embodiments, the perspective of the object is known and is provided to the system along with the plurality of input images.

At operation 610, the system encodes the set of input images to obtain a set of 2D features corresponding to the set of input images, respectively. In some cases, the operations of this step refer to, or may be performed by, an image encoder as described with reference to FIGS. 7, and 9-11. In some cases, for example, the 2D features includes visual information and the view angle information of the object depicted in each of the plurality of input images. For example, the visual information may include pixel data, metadata (e.g., image resolution and color depth), color space information, semantic information, contextual information, and/or spatial relationships.

At operation 615, the system generates, using a 2D-to-3D transformer, 3D features based on the set of 2D features and the set of 3D position embeddings. In some cases, the operations of this step refer to, or may be performed by, a 2D-to-3D transformer as described with reference to FIGS. 7, 9, and 10. In some cases, the 3D features include combined information from the 2D features that represent the object in 3D space. For example, the 3D features include information such as 3D coordinate information of the object depicted in the input images, depth information, surface normal, pose information, texture, lighting, and shading. For example, the depth information represents the distance of each pixel from the viewpoint (e.g., from the perspective each input image). For example, the surface normal provides information about the geometry of the object. For example, the pose information includes details about the orientation and position of the object in 3D space. For example, the texture includes surface details that describe the appearance of the surface of the object in 3D space. For example, the lighting and shading include information about how a light source interacts with the object, also including shadows and reflections.

At operation 620, the system generates a 3D model of the object based on the 3D features. In some cases, the operations of this step refer to, or may be performed by, a reconstruction model as described with reference to FIGS. 7-10. In some embodiments, triplane features are generated based on the 3D features. For example, the triplane features captures the spatial features of a 3D volume. Further detail on the triplane features is described with reference to FIGS. 9-10.

### System Architecture

In FIGS. 7-11 and 14, an apparatus and system for 3D model generation include at least one processor, at least one memory storing instructions executable by the at least one processor, an image encoder comprising parameters stored in the at least one memory and trained to encode a plurality of input images to obtain a plurality of 2D features corresponding to the plurality of input images depicting an object, respectively, and a 2D-to-3D transformer comprising parameters stored in the at least one memory and trained to generate 3D features based on the plurality of 2D features and a set of 3D position embeddings.

In some aspects, the 2D-to-3D transformer comprises a cross-attention layer and a self-attention layer. Some examples of the apparatus and system further include a triplane component configured to generate triplane features based on the 3D features. Some examples of the apparatus and system further include a pose model trained to generate pose information for each of the plurality of input images.

FIG. 7 shows an example of a 3D model generation apparatus according to aspects of the present disclosure. The example shown includes 3D model generation apparatus 700, processor unit 705, I/O module 710, memory unit 715, and training component 750. In one aspect, memory unit 715 includes reconstruction model 720, image encoder 725, 2D-to-3D transformer 730, triplane component 735, pose model 740, and image generation model 745.

According to some embodiments of the present disclosure, 3D model generation apparatus 700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. 3D model generation apparatus 700 is an example of, or includes aspects of, the corresponding element described with reference to FIG. 1.

Processor unit 705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special-purpose components for modem processing, baseband processing, digital signal processing, or transmission processing. Processor unit 705 is an example of, or includes aspects of, the processor described with reference to FIG. 14.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 710 is an example of, or includes aspects of, the I/O interface described with reference to FIG. 14.

Examples of memory unit 715 include random access memory (RAM), read-only memory (ROM), or a hard disk. Examples of memory unit 715 include solid-state memory and a hard disk drive. In some examples, memory unit 715 is used to store computer-readable, computer-executable software including instructions that, when executed, cause a processor to perform various functions described herein.

In some cases, memory unit 715 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 715 store information in the form of a logical state.

In one aspect, memory unit 715 includes a machine learning model. In one aspect, memory unit 715 includes reconstruction model 720, image encoder 725, 2D-to-3D transformer 730, triplane component 735, pose model 740, and image generation model 745. Memory unit 715 is an example of, or includes aspects of, the memory subsystem described with reference to FIG. 14.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 715 and executable by processor unit 705, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, reconstruction model 720 is implemented as software stored in memory unit 715 and executable by processor unit 705, as firmware, as one or more hardware circuits, or as a combination thereof. In some aspects, reconstruction model 720 obtains a set of input images depicting an object and a set of 3D position embeddings, where each of the set of input images depicts the object from a different perspective. In some examples, reconstruction model 720 generates a 3D model of the object based on the 3D features. In some examples, reconstruction model 720 generates an output image based on the 3D model, where the output image depicts the object from a perspective different from the set of input images.

According to some aspects, reconstruction model 720 obtains view information for each of the set of input images, where the set of input images are encoded based on the view information. According to some aspects, reconstruction model 720 generates an output image based on the 3D features. In some examples, reconstruction model 720 generates a 3D model based on the 3D features. Reconstruction model 720 is an example of, or includes aspects of, the corresponding element described with reference to FIGS. 8-10.

According to some aspects, image encoder 725 is implemented as software stored in memory unit 715 and executable by processor unit 705, as firmware, as one or more hardware circuits, or as a combination thereof. According to some aspects, image encoder 725 encodes the set of input images to obtain a set of 2D features corresponding to the set of input images, respectively. In some examples, image encoder 725 obtains a reference view encoding for a first image of the set of input images and a source view encoding for a second image of the set of input images, where the first image is encoded based on the reference view encoding and the second image is encoded based on the source view encoding. In some examples, image encoder 725 obtains view intrinsic parameters of each of the set of input images, where the set of input images are encoded based on the view intrinsic parameters.

According to some aspects, image encoder 725 comprises parameters stored in the at least one memory and trained to encode a plurality of input images to obtain a plurality of 2D features corresponding to the plurality of input images depicting an object, respectively. Image encoder 725 is an example of, or includes aspects of, the corresponding element described with reference to FIGS. 9-11.

According to some aspects, 2D-to-3D transformer 730 is implemented as software stored in memory unit 715 and executable by processor unit 705, as firmware, as one or more hardware circuits, or as a combination thereof. According to some aspects, 2D-to-3D transformer 730 generates 3D features based on the set of 2D features and the set of 3D position embeddings. In some examples, 2D-to-3D transformer 730 performs an attention mechanism on the set of 2D features and the set of 3D position embeddings. In some examples, 2D-to-3D transformer 730 generates a set of image-specific output features corresponding to the set of input images, respectively. In some examples, 2D-to-3D transformer 730 generates pose information for each of the set of input images based on the set of image-specific output features. In some aspects, the 2D-to-3D transformer 730 is trained using a training set that includes a set of training images depicting different views of a scene.

According to some aspects, 2D-to-3D transformer 730 generates pose information for a training image from the set of training images. According to some aspects, 2D-to-3D transformer 730 comprises parameters stored in the at least one memory and trained to generate 3D features based on the plurality of 2D features and a set of 3D position embeddings. In some aspects, the 2D-to-3D transformer 730 includes a cross-attention layer and a self-attention layer. 2D-to-3D transformer 730 is an example of, or includes aspects of, the corresponding element described with reference to FIGS. 9 and 10.

According to some aspects, triplane component 735 is implemented as software stored in memory unit 715 and executable by processor unit 705, as firmware, as one or more hardware circuits, or as a combination thereof. According to some aspects, triplane component 735 generates triplane features based on the 3D features, where the 3D model is generated based on the triplane features. According to some aspects, triplane component 735 is configured to generate triplane features based on the 3D features. Triplane component 735 is an example of, or includes aspects of, the corresponding element described with reference to FIGS. 9 and 10.

According to some aspects, pose model 740 is implemented as software stored in memory unit 715 and executable by processor unit 705, as firmware, as one or more hardware circuits, or as a combination thereof. According to some aspects, pose model 740 is trained to generate pose information for each of the plurality of input images. Pose model 740 is an example of, or includes aspects of, the corresponding element described with reference to FIG. 10.

According to some aspects, image generation model 745 is implemented as software stored in memory unit 715 and executable by processor unit 705, as firmware, as one or more hardware circuits, or as a combination thereof. According to some aspects, image generation model 745 obtains an input prompt describing the object. In some examples, image generation model 745 generates the set of input images based on the input prompt. Image generation model 745 is an example of, or includes aspects of, the corresponding element described with reference to FIGS. 4 and 8.

According to some aspects, training component 750 is implemented as software stored in memory unit 715 and executable by processor unit 705, as firmware, as one or more hardware circuits, or as a combination thereof. According to some embodiments, training component 750 is implemented as software stored in a memory unit and executable by a processor in the processor unit of a separate computing device, as firmware in the separate computing device, as one or more hardware circuits of the separate computing device, or as a combination thereof. In some examples, training component 750 is part of another apparatus other than 3D model generation apparatus 700 and communicates with the 3D model generation apparatus 700. In some examples, training component 750 is part of 3D model generation apparatus 700.

According to some embodiments, training component 750 may train the reconstruction model 720, the 2D-to-3D transformer 730, the pose model 740, and the image generation model 745. In some cases, for example, parameters of the image generation model 745 can be learned or estimated from training data and then used to make predictions or perform tasks based on learned patterns and relationships in the data. In some cases, parameters of the 2D-to-3D transformer 730can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output (e.g., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the trained model (e.g., the 2D-to-3D transformer 730 or the image generation model 745) can be used to make predictions on new, unseen data (e.g., during inference).

According to some aspects, training component 750 obtains a training set including a set of training images depicting different views of a scene. In some examples, training component 750 initializes a 2D-to-3D transformer 730. In some examples, training component 750 trains, using the training set, the 2D-to-3D transformer 730 to generate 3D features based on based on a set of 2D features and a set of 3D position embeddings, where the set of 2D features corresponds to a set of input images. In some examples, training component 750 trains an image generation model 745 to generate the set of input images based on a text prompt.

In some examples, training component 750 computes a reconstruction loss based on the output image and a training image from the set of training images. In some examples, training component 750 computes a perceptual loss based on the output image and the training image. In some examples, training component 750 computes a pose loss based on the pose information. In some examples, training component 750 computes a 3D model loss based on the 3D model and a ground-truth 3D model of an object.

FIG. 8 shows an example of a text-to-3D model 830 according to aspects of the present disclosure. The example shown includes machine learning model 800, text prompt 805, image generation model 815, synthetic image 820, reconstruction model 825, and 3D model 830. In some cases, the example shown further includes Gaussian blob 810 used during the inference stage to generate the synthetic image 820 using the image generation model 815.

According to some embodiments, the machine learning model 800 generates high-quality and diverse 3D models (e.g., 3D model 830) conditioned on text (e.g., the text prompt 805) or images in a feed-forward manner. According to some embodiments, a two-stage paradigm is used to generate 3D models including a sparse-view generation stage (e.g., the generation of the synthetic image 820) and a sparse reconstruction stage (e.g., the generation of the 3D model 830). During the first stage, the machine learning model 800 fine-tunes a text-to-image diffusion model (e.g., the image generation model 815) to generate consistent multi-view images of an object based on the text prompt 805. In some cases, the machine learning model 800 uses multi-view renderings of 3D objects to finetune the image generation model 815. In some embodiments, the machine learning model 800 generates a sparse set of 4-view images (e.g., the synthetic image 820) in the form of a 2 by 2 grid in a single operation. As a result, multi-view images are generated to attend to each other during the generation which leads to more consistent results. During the second stage, a scalable transformer-based model (e.g., the reconstruction model 825) is trained to predict a 3D model 830 of the object depicted in the synthetic image 820. In some cases, for example, the reconstruction model 825 is trained on multi-view rendered images of around 1 million 3D objects. For example, the reconstruction model 825 takes a four-view image (e.g., the synthetic image 820) as input and generates a 3D reconstruction of the object in the form of triplanes by minimizing the reconstruction loss between the 3D reconstruction renderings at novel views and the ground truth images. Accordingly, the machine learning model 800 can robustly infer the correct geometry and appearance of the object from a set of 4 images (or 4 different views of an object).

According to some embodiments, the machine learning model 800 includes a feed-forward architecture (e.g., the reconstruction model 825) that can generate images based on a text prompt 805 without using massive computational resources. According to some embodiments, the machine learning model 800 also supports image-conditioned 3D generation by fixing one of the input views during the first stage, which gives more fine-grained control over the generated 3D model. For example, one of the views of the object depicted in the synthetic image is the input image/view of the object. According to some embodiments, the machine learning model 800 generates high-quality and diverse 3D models conditioned based on text or images in a feed-forward manner. According to some embodiments, the machine learning model 800 generates sparse, view-consistent images (e.g., synthetic image 820) based on a text prompt 805 or an image prompt by fine-tuning 2D diffusion models (e.g., the image generation model 815) on 3D data. According to some embodiments, the machine learning model 800 generates high-quality 3D models (e.g., the 3D model 830) from sparse multi-view images (e.g., the synthetic image 820) using the reconstruction model 825.

Referring to FIG. 8, the machine learning model 800 receives text prompt 805 that states “A car made out of sushi” and generates 3D model 830 that depicts the sushi car. In some aspects, the machine learning model 800 includes an image generation model 815 trained to generate synthetic image 820 based on the text prompt 805. In some cases, for example, the image generation model 815 includes a fine-tuned text-to-image diffusion model or SDXL model. For example, the image generation model 815 is trained to generate an image with a 2×2 grid including 4 views of the object described in the text prompt 805. In some cases, the 4 views are the front view, left-side view, back view, and right-side view, respectively corresponding to 0° (or) 360°, 90°, 180°, 270°. In some cases, the image generation model 815 can be trained to generate different views of the object in the synthetic image 820. For example, the synthetic image 820 may include an isometric view, oblique view, perspective view, axonometric view, dimetric view, trimetric view, section view, exploded view, or a combination thereof. In some cases, the synthetic image 820 may include more than 4 views of the object described in the text prompt 805. In some cases, the synthetic image 820 may include less than 4 views of the object described in the text prompt 805.

In some embodiments, the machine learning model 800 compiles the images of an object at different views into a single image in the form of an image grid instead of generating views one-by-one conditioned on the camera poses. The image generation model 815 is fine-tuned to generate the image grid based on the input prompt (e.g., the text prompt 805). By fine-tuning the image generation model 815, the image generation model 815 is able to generate the multi-view images in a single operation. Additionally, during the generation process, the self-attention scheme in the image generation model 815 allows the images at the different views to attend to each other. Accordingly, the consistency of the generation of multi-view images is increased. Additionally, by fine-tuning the image generation model 815, no changes are implemented to the architecture of the image generation model 815, thus resulting in high flexibility of the image generation model 815.

In some embodiments, the generation of the number of views of an object can be altered. In some cases, for example, more generated views may lead to an easier 3D reconstruction. However, this may increase the overlaps between different views and thus resulting in the possibility of inconsistency. In some cases, for example, too few views may lead to insufficient coverage, and the reconstruction model 825 may hallucinate or assume the unseen part, resulting in inaccurate generation of the 3D model 830. Furthermore, combining more views into a single image grid reduces the resolution for each view image, which may cause the reconstruction model 825 to underperform. According, the image generation model 815 generates a set of 4 views that are combined into a 2×2 image grid. As a result, in the second stage, the reconstruction model 825 can accurately reconstruct the 3D model 830 without reducing the consistency and image resolution. In some embodiments, the four views are distributed at a fixed elevation (20 degrees) and four equidistant azimuths (e.g., 0, 90, 180, 270 degrees) to achieve a better coverage of the object described by the text prompt 805.

According to some embodiments, the image generation model 815 is initialized with Gaussian blob 810. For example, the image generation model 815 is fine-tuned on multi-view images with a white background. During the inference time, the image generation model 815 begins from standard Gaussian noise resulting in low-quality images that have cluttered background, which introduces extra difficulty for the feed-forward reconstructor in the second stage. To guide the image generation model 815 toward generating synthetic images with a clean white background, the image generation model 815 generates an image of a 2×2 grid that has the resolution as the output images, and for each sub-image (i.e., each view of the object in each of the quadrants of the synthetic image 820), the image generation model 815 is initialized with a Gaussian blob 810 disposed at the center of the image with a standard deviation. In some embodiments, the Gaussian blob image grid is provided to an autoencoder to generate the latent representation. Then, noise is added (for example, with a time constant T; 1000, e.g., T=980 for 50 diffusion steps) to the latent representation. Then, the added noise to the latent representation is used as the starting point for the denoising process in the image generation model 815. Accordingly, the image generation model 815 is effectively biased toward generating images with white background.

In some cases, the machine learning model 800 modifies the initial iteration of Gaussian noise and an image with object quadrants and white background. The image is generated by a grayscale image with a clean white background and a black Gaussian blob 810 at the center. For example, a grayscale image I having a dimension of H×W is constructed, where H and W are the height and width of the input RGB image with a value range [0,1]. In some cases, the height and the width are substantially the same. In some cases, the height H and width W are represented as S. For a given pixel (x,y), the pixel value can be computed as:

$$I ( x , y ) = 1 - exp ( - \frac{{( x - S / 2 )}^{2} + {( y - S / 2 )}^{2}}{2 {σ}^{2} {S}^{2}} ) \qquad ( 1 )$$

where σ is a hyper-parameter controlling the width of the Gaussian blob 810. In some cases, four of these images are combined into a 2×2 image grid.

In some cases, the initial noise for the denoising step is obtained by blending a complete Gaussian noise with the latent of the Gaussian blob 810. For example, the latent of the Gaussian blob image I is represented as I, and the latent of a noise image with Gaussian values as €. For a N step denoising inference process with timesteps {ty, tN-1, . . . , to}, the latents can be combined with a weighted sum as:

$${ϵ}_{{t}_{N}} = \sqrt{{\overline{α}}_{{t}_{N}}} \tilde{I} + \sqrt{1 - {\overline{α}}_{{t}_{N}}} ϵ \qquad ( 2 )$$

where ϵₜ_{_{N}} is used as the initial noise of the denoising process.

According to some embodiments, the machine learning model 800 is extended to support additional image conditioning to provide fine-grained control over the generation of the 3D model 830. For example, the input to the machine learning model 800 includes an text prompt 805 that describes the object to be generated and an input image of the object. In some cases, the same training data as the text-conditional method is used for the image-conditional method. For example, during training, for a randomly sampled time step t, the machine learning model 800 maintains the first image at the top-left quadrant of the synthetic image 820 and adds noise to the remaining three views. As a result, the image generation model 815 is able to generate the other views while accounting for the full information about the conditioned image. By preserving the latent at the top-left quadrant and adding noise to the latents of other quadrants, the machine learning model 800 is able to spatially align with the original image. To mitigate the range scaling gap between the clean latents and the noisy latents, the clean latents is scaled. In some cases, the training loss is the same as the original conditioned model. Further detail on the training loss is described with reference to FIG. 13. Accordingly, the image generation model 815 learns to denoise and generate the other three views based on the first view.

During inference, the image generation model 815 begins at a latent space where the upper-left quadrant contains the clean latent of the conditioned image. The other quarters are initialized with noisy Gaussian blobs (e.g., the Gaussian blob 810). At every diffusion step (or at every DDIM step in some embodiments), the top-left quarter of the resulting latent is replaced with the clean latent of the conditioned image. After completing the denoising process, the remaining three quadrants is decoded to generate three different views of the object consistent with the object depicted in the input image. Accordingly, the first view of the synthetic image 820 is identical to the conditioned input view image.

According to some embodiments, during the second stage, the synthetic image 820 is provided to the reconstruction model 825 to generate 3D model 830. For example, the reconstruction model 825 includes an image encoder configured to generate a set of 2D image features based on the synthetic image 820. The reconstruction model 825 also includes a 2D-to-3D transformer trained to convert the set of 2D features into 3D features. Then, the reconstruction model 825 can generate the 3D model 830 based on the 3D features. Further detail on the reconstruction model 825 is described with reference to FIG. 9.

Machine learning model 800 is an example of, or includes aspects of, the corresponding element described with reference to FIGS. 3-5. Text prompt 805 is an example of, or includes aspects of, the corresponding element described with reference to FIGS. 3 and 11. Image generation model 815 is an example of, or includes aspects of, the corresponding element described with reference to FIGS. 4 and 7.

Synthetic image 820 is an example of, or includes aspects of, the corresponding element described with reference to FIG. 4. Reconstruction model 825 is an example of, or includes aspects of, the corresponding element described with reference to FIGS. 7, 9, and 10. 3D model 830 is an example of, or includes aspects of, the corresponding element described with reference to FIGS. 3-5, 9, and 10.

FIG. 9 shows an example of a first reconstruction model according to aspects of the present disclosure. The example shown includes reconstruction model 900, input views 905, input convolutional layer 910, image encoder 915, view feature 930, modulation layer 935, 2D image features 940, 3D position embeddings 945, 2D-to-3D transformer 950, 3D features 970, triplane component 975, triplane features 980, rendering component 985, and 3D model 990. In one aspect, reconstruction model 900 includes image encoder 915, modulation layer 935, 2D-to-3D transformer 950, triplane component 975, and rendering component 985. In one aspect, image encoder 915 includes first self-attention layer 920 and first multilayer perceptron 925. In one aspect, 2D-to-3D transformer 950 includes cross-attention layer 955, second self-attention layer 960, and second multilayer perceptron 965.

During the feed-forward process, 3D model 990 is reconstructed from the four-view image ∫ₒ={Iᵢ| i=1, . . . 4} (e.g., the input views 905) generated at the first stage. In some cases, the four views are divided into four images. In some cases, since the four views are generated from the first-stage model that is fine-tuned to output structured multi-view images, the pose information Pᵢ∈R^{4×4} and intrinsic parameter Kᵢ∈R^{4×4} of each image are also generated. For example, view feature 930 includes the pose information and the intrinsic parameter for the input views 905. In some embodiments, a plurality of view features each includes the pose information and the intrinsics of each of the input views is provided to the reconstruction model 900.

In some cases, pose information may be referred to as the camera information or camera pose. In one aspect, pose information refers to the position and orientation of a view point (e.g., a camera or an observer) in a 3D space. The pose information describes how the view point is situated and pointed with respect to the world coordinate system. In some cases, the pose information may be represented as Euler angles, where the Euler angles describe rotations around the coordinate axes. In some cases, the pose information may be represented as quaternions, where the quaternions represents the orientation of the view point. In some cases, the quaternions are represented in a 3×3 matric that describe how the view point is rotated around the X, Y, and Z axes.

In some cases, for example, the intrinsic parameter (sometimes referred to as intrinsics or camera intrinsics) is an internal parameter of a view point (e.g., a camera) that affects how the view point captures the image. In some cases, for example, the intrinsic parameter includes optical characteristics of the camera and is independent of the position and orientation of the camera. In some cases, the intrinsic parameter is represented as a matrix that includes information about focal length, principal point, skew coefficient, and distortion coefficients. For example, the focal length determines the zoom level of the camera. For example, the principal point represents a point where the optical axis intersects the image plane. For example, the skew coefficient represents the skewness of the camera sensor's pixel grid. In many cases, the skew coefficient is 0. For example, distortion coefficient represents the radial and tangential distortion of the lens of the camera, affecting how straight lines appear in the image.

According to some embodiments, the input views 905 are provided to the input convolutional layer 910, where the output of the input convolutional layer 910 is provided to the image encoder 915. In some cases, the view feature 930 is provided to the modulation layer 935, where the output of the modulation layer 935 is provided to the image encoder 915. In some embodiments, the output from the input convolutional layer 910 representing each of the input views is combined with the output from the modulation layer 935 representing the respective pose information and intrinsics.

In some cases, 3D reconstruction from sparse inputs with a large baseline requires strong data priors to resolve the inherent ambiguity. The reconstruction model 900 predicts a 3D model 990 from a sparse set of the input views 905. The reconstruction model 900 includes an image encoder 915, a 2D-to-3D transformer 950, a triplane component 975, and a rendering component 985. In one aspect, the image encoder 915 encodes the multi-view images (or input views 905) into a set of tokens (or 2D image features 940). The image tokens are provided to the 2D-to-3D transformer 950 to output a triplane representation (or the triplane feature 980) for the object depicted in the input views 905. Then, the triplane features 980 are rendered into per-point density and colors using the rendering component 985 to generate the 3D model.

In some cases, triplane features 980 includes information of the 3D object to be modeled in three orthogonal planes (XY, YZ, and XZ). For example, each plane captures 2D spatial features of the 3D volume such as textures, edges, and shapes. For example, the XY plane captures features along the width and height of the volume, the YZ plane captures features along the height and depth of the volume, and the XZ plane captures features along the width and depth of the volume. In some cases, the three orthogonal planes are combined to generate a detailed 3D representation of the object to be modeled.

According to some embodiments, the image encoder 915 generates the 2D image features 940 based on the input views 905 and view feature 930. In one aspect, the image encoder 915 includes a first self-attention layer 920 and a first multilayer perceptron 925. For example, the image encoder 915 includes a pretrained Vision Transformer (ViT) DINO. To support multi-view inputs, the pose information is provided to the image encoder 915 so that the output image tokens (e.g., the 2D image features 940) are pose-aware. For example, the camera information of each view is flattened, including the extrinsic and intrinsic, into a 20-dimension vector f_{c}, which includes 16 dimensions for the extrinsic parameter (Pᵢ) and 4 dimensions for the intrinsic parameter (including focal length fₓ, f_{y} and principal point cₓ, c_{y}). For each input feature f_{I}_{ᵢ}, to the first self-attention layer 920 and the first multilayer perceptron 925 of the image encoder 915 at image Iᵢ, camera information is provided in an AdaIN manner, where the first multilayer perceptron 925 is used to decode a set of per-dim scaling and shifting parameters from the camera vector f_{c}:

$$λ , β = MLP ( {c}_{i} ) \qquad ( 3 )$$

$${f}_{{I}_{i}}^{mod} = {f}_{{I}_{i}} \cdot ( 1 + λ ) + β \qquad ( 4 )$$

Accordingly, the final output of the image encoder 915 is a set of pose-aware image features f_{I}_{ᵢ}* (e.g., the 2D image features 940), and the per-view features are concatenated together as the feature descriptors for the multi-view images: f_{I}=⊕(f_{I}_{ᵢ}*, . . . f_{I}_{₄}*). Additionally, a triplane T∈R^{3×H×W×C} (e.g., the 3D position embeddings 945) is used as the scene representation, where H, W, C are the height, width and number of feature channels of the triplane, respectively. The triplane is represented as a set of learnable tokens (e.g., the 3D position embeddings 945), and the 2D-to-3D transformer 950 connects the triplane tokens (e.g., the 3D position embeddings 945) with the pose-aware image tokens f_{I} (e.g., the 2D image features) using cross-attention layer 955, followed by a second self-attention layer 960, and a second multilayer perceptron 965. In one aspect, the 2D-to-3D transformer 950 includes the cross-attention layer 955, the second self-attention layer 960, and the second multilayer perceptron 965. In some cases, the final output token (e.g., the 3D features 970) is generated.

In some embodiments, a triplane component 975 generates triplane features 980 based on the 3D features 970. For example, the final output tokens (e.g., the 3D features 970) are reshaped and upsampled using a de-convolution layer to the final triplane features (e.g., the triplane features 980). In some embodiments, a rendering component 985 is configured to render the 3D model representing the object depicted in the input views 905 based on the triplane features 980.

During training, a ray is applied through the scene and the model decodes the triplane features 980 at each point to obtain density and color using a shared MLP. In some cases, the machine learning model obtains pixel color via volume rendering. In some cases, the networks are trained in an end-to-end manner with image reconstruction loss at novel views using a combination of MSE loss and LPIPS loss.

In some aspects, the image encoder 915 includes the first self-attention layer 920 and the first multilayer perceptron 925. In some aspects, the 2D-to-3D transformer 950 includes the cross-attention layer 955, the second self-attention layer 960, and the second multilayer perceptron 965. In some embodiments, the first self-attention layer 920 and the second self-attention layer 960 may be substantially the same. In some embodiments, the first multilayer perceptron 925 and the second multilayer perceptron 965 may be substantially the same.

A self-attention layer (e.g., the first self-attention layer 920 and the second self-attention layer 960) enables a model (e.g., the image encoder 915 or 2D-to-3D transformer 950) to weigh the importance of different parts of a sequence relative to each other. In some cases, the self-attention layer computes attention scores for each pair of elements in the sequence, where the model can understand relationships within the same sequence. In some cases, each element of the sequence attends to all other elements, including the element itself. In some cases, for example, the attention scores is calculated using a similarity function (e.g., scaled dot-product) between pairs of elements. In some cases, the output of the self-attention layer is a weighted sum of the input elements (e.g., the features), where weights are the attention scores.

A cross-attention layer (e.g., the cross-attention layer 955) enables a model (e.g., the 2D-to-3D transformer 950) to focus on different parts of a source sequence when generating or processing a target sequence. the cross-attention layer computes attention scores between elements of two different sequences, where the attention scores are used to align one sequence with another. In some cases, each element of the target sequence attends to all elements of the source sequence. In some cases, the attention score is calculated between elements of the target and source sequences using a similarity function. In some cases, the output of the cross-attention layer is the weighted sum of the source sequence elements, where weights are the attention scores.

A multilayer perceptron (MLP) (e.g., the first multilayer perceptron 925 and the second multilayer perceptron 965) is a type of feedforward artificial neural network (ANN) including multiple layers of nodes, an input layer, one or more hidden layers, and an output layer. Each node in a layer is connected to every node in the subsequent layer, and each connection has an associated weight. In some cases, the MLP transforms input data into an output by applying a series of weighted sums and activation functions, where the MLP is capable of learning complex functions and representations.

Reconstruction model 900 is an example of, or includes aspects of, the corresponding element described with reference to FIGS. 7, 8, and 10. Input views 905 is an example of, or includes aspects of, the corresponding element described with reference to FIGS. 5 and 10. Image encoder 915 is an example of, or includes aspects of, the corresponding element described with reference to FIGS. 7, 10, and 11.

2D image features 940 is an example of, or includes aspects of, the corresponding element described with reference to FIG. 10. 3D position embeddings 945 is an example of, or includes aspects of, the corresponding element described with reference to FIG. 10. 2D-to-3D transformer 950 is an example of, or includes aspects of, the corresponding element described with reference to FIGS. 7 and 10. 3D features 970 is an example of, or includes aspects of, the corresponding element described with reference to FIG. 10.

Triplane component 975 is an example of, or includes aspects of, the corresponding element described with reference to FIGS. 7 and 10. Triplane features 980 is an example of, or includes aspects of, the corresponding element described with reference to FIG. 10. Rendering component 985 is an example of, or includes aspects of, the corresponding element described with reference to FIG. 10. 3D model 990 is an example of, or includes aspects of, the corresponding element described with reference to FIGS. 3-5, 8, and 10.

FIG. 10 shows an example of a second reconstruction model according to aspects of the present disclosure. The example shown includes reconstruction model 1000, input views 1005, image encoder 1010, 2D image features 1015, reference view encoding 1020, source view encoding 1025, view intrinsic parameters 1030, MLP 1035, view intrinsic features 1040, 3D position embeddings 1045, 2D-to-3D transformer 1050, 3D features 1065, triplane component 1070, triplane features 1075, rendering component 1080, 3D model 1082, image-specific output features 1084, pose model 1086, and pose information 1088. In one aspect, reconstruction model 1000 includes image encoder 1010, MLP 1035, 2D-to-3D transformer 1050, triplane component 1070, rendering component 1080, and pose model 1086. In one aspect, 2D-to-3D transformer 1050 includes self-attention layer 1055 and multilayer perceptron 1060.

According to some embodiments of the disclosure, the system is able to generate a 3D model of an object based on a plurality of input images (or input views) depicting the object, where each of the plurality of input images depicts the object from a different, unknown view point. In some cases, the system is able to generate pose information for each of the input images relative to one another in the context of the generated 3D model.

In some cases, a sparse set of images or views (e.g., input views 1005) is provided as input to the reconstruction model 1000 to reconstruct the 3D model 1082 and pose information for each image. For example, the machine learning model applies a feed-forward model to direct inference of the 3D representation and camera poses. For example, the system includes an image encoder 1010 configured to encode the input views 1005. Then, the reconstruction model 1000 applies a single-stream transformer to transform the NeRF tokens and ViT tokens. In some cases, the reconstruction model 1000 uses the NeRF tokens to represent the triplane features and the ViT tokens to estimate the camera poses.

According to some embodiments, the reconstruction model 1000 applies tokenization to both the input views 1005 and the triplane features 1075. Then, the self-attention mechanism is used to model the information exchanges among these tokens. In addition to reconstructing the 3D model 1082, the reconstruction model 1000 also predicts the pose information 1088 for all source views relative to a reference view among the input views. In some cases, two additional view encoding vectors are provided to the reconstruction model 1000, e.g., a first additional view encoding vector (e.g., the reference view encoding 1020) for the reference view and a second additional view encoding vector (e.g., a source view encoding) for all source views, for modulating the image patch tokens.

In some embodiments, the input views 1005 are provided to the image encoder 1010 to generate 2D image features. In some cases, reference view encoding 1020, source view encoding 1025, view intrinsic parameters 1030 are provided to the image encoder 1010. For example, for the first view among the input views 1005, a reference view encoding 1020 is used to set up the view point information. Then, for the remaining views among the input views 1005, a source view encoding 1025 is used to set up the view point information. In some cases, the paired input view and the view encoding are provided to the image encoder 1010. In some embodiments, view intrinsic parameters 1030 are provided to an MLP 1035 to generate view intrinsic features 1040. Each of the view intrinsic features 1040 is added to the corresponding input view and the view encoding to obtain the combined feature. In some embodiments, the image encoder 1010 generates the 2D image features 1015 based on the combined feature.

In some cases, for example, the image encoder 1010 includes a pretrained DINO Vision Transformer configured to tokenize the input views 1005. For example, DINO includes a patch size of 16×16 and 16-layer transformer of width 768. Each of the input views 1005 having a resolution of H×W is tokenized into H/16×W/16 tokens of 768-dimension.

In some embodiments, the image encoder 1010 bilinearly interpolate the original positional embedding to a target image size. For each view, the view encoding vector (e.g., the reference view encoding 1020 and source view encoding 1025) and the intrinsic parameter (e.g., the view intrinsic parameters) are mapped to a modulation feature, then passed to the adaptive layer norm block to predict scale and bias for modulating the intermediate feature activations inside each transformer block (e.g., self-attention and MLP) of the image encoder 1010. Thus, the modulation feature mᵣ can be represented as:

$${m}_{r} = {MLP}^{intrin .} ( [ {f}_{x} , {f}_{y} , {c}_{x} , {c}_{y} ] ) + {v}_{r} \qquad ( 5 )$$

where fₓ, f_{y}, cₓ, c_{y} are camera intrinsics (e.g., view intrinsic parameter 1030) and vr is the view encoding vector (e.g., the reference view encoding 1020 and/or source view encoding 1025).

According to some embodiments, the image tokens (e.g., 2D image features 1015) and the learnable triplane position embedding (e.g., 3D position embeddings 1045) are concatenated to obtain a token sequence, where the token sequence is provided to the 2D-to-3D transformer 1050. In some cases, the 2D-to-3D transformer 1050 includes multi-head attention with head dimension 64. During the rendering process, the three planes of the triplane component 1070 are queried independently and the three features are concatenated as input to the rendering component 1080 to generate the RBG color and NeRF density. In some embodiments, the pose model 1086 includes a PnP solver configured to generate per-view geometry prediction. For example, the image tokens (e.g., the 2D image features 1015) generated by the 2D-to-3D transformer 1050 are provided to MLP layers to obtain the point predictions, the confidence predictions, and the alpha predictions.

Embodiments of the disclosure utilizes two 768-dimensional learnable features which serve as view encoding vectors (e.g., the reference view encoding 1020 and source view encoding 1025). For example, the first view encoding vector (e.g., the reference view encoding 1020) is used to modulate the tokens corresponding to the reference view among the input views 1005, and the second vector (e.g., the source view encoding 1025) is applied to modulate the patch tokens of each individual source view among the input views 1005. Accordingly, the reconstruction model 1000 is able to distinguish between tokens associated with the reference view and those related to the various source views. The reconstruction model 1000 predicts relative poses, wherein the tokens from the reference view function as contextual references for the source view tokens. As a result, the view encoding mechanism is used to effectively mark the vital context tokens.

According to some embodiments, 3D position embeddings 1045 and the 2D image features 1015 are provided to the 2D-to-3D transformer 1050 to generate 3D features. In some cases, a triplane component 1070 is configured to generate triplane features 1075 based on the 3D features 1065. In some cases, a rendering component 1080 is configured to render the 3D model 1082 based on the triplane features 1075.

In some embodiments, the 2D-to-3D transformer 1050 tokenizes the triplane of shape 3×H′×W′×C′ (where H′, W′ are spatial resolution and C′ is the channel dimension) into 3×H′×W′ tokens. To obtain these tokens, the 2D-to-3D transformer 1050 learns to translate 3×H′×W′ learnable triplane tokens of 768-dimension (e.g., the 3D position embeddings 1045) into the target triplane tokens through self-attention layer 1055 based on the image tokens (e.g., the 2D image features 1015) and triplane tokens (the 3D position embeddings 1045). Then, the multilayer perceptron 1060 transforms the token dimension from 768 to C′.

To predict the NeRF density and colors at each 3D point, a second MLP (e.g., the triplane component 1070) is used to convert the tri-linearly interpolated triplane feature. Then, the rendering component 1080 performs volume rendering to generate the final color image that represents the 3D model 1082. The second MLP is shared for all predicted triplanes and is trained with the transformer. In some cases, the rendering component 1080 generates the 3D model 1082 based on the triplane features 1075.

Embodiments of the present disclosure support a variable number of input views based on sharing one view encoding vector among all source views and employing the self-attention architecture. In some cases, adding or reducing the number of images may be performed in a way similar to increasing or shortening sentences in GPT-style language models.

In some embodiments, the reconstruction model 1000 includes a pose model 1086 (e.g., a differentiable PnP solver) to determine pose information 1088 based on 3D-2D correspondences. In some embodiments, the 2D-to-3D transformer 1050 generates the 3D features 1065 and the image-specific output features 1084, where each of the image-specific output features 1084 includes predicted pose information for each view of the input views 1005. In some embodiments, the pose model 1086 generates the pose information 1088 based on the image-specific output features 1084. For example, the 3D correspondences originate from the predicted 3D point coordinate of each patch, while the 2D correspondences are from the centers of each patch's 2D pixel coordinate.

For example, given an object proposal X={pᵢ, xᵢ, wᵢ|i∈1 . . . . N}, with pᵢ∈R³, the 3D point coordinates, xᵢ∈R², the 2D image coordinates and wᵢ∈R₊² the 2D weights, a weighted PnP problem can be formulated as minimizing the cumulative squared weighted reprojection error:

$${arg min}_{y = [ R , t ]} \frac{1}{2} {\sum }_{i = 1}^{N} {‖ {f}_{i} ( y ) ‖}^{2} , {f}_{i} ( y ) = {w}_{i} ∘ ( P ( R \cdot {p}_{i} + t ) ) - {x}_{i} , \qquad ( 6 )$$

where f(·) represents the reprojection error, P is the projection function with camera intrinsics involved, ° is the element-wise product operation and y=[R, t] denotes the rotation matrix and translation vector, respectively.

However, the equation above formulates a non-linear least square problem that can lead to non-unique solutions due to pose ambiguities, such as symmetric rotation and/or self-occlusion ambiguity. For end-to-end learning, a differentiable PnP solver is construed in a way that models the PnP output as a distribution of pose, which ensures differentiable probability density. With Bayes' theorem and uninformative prior assumption, the posterior density of pose can be derived as follows:

$$p ( y \vert X ) = \frac{exp - \frac{1}{2} {\sum }_{i = 1}^{N} {‖ {f}_{i} ( y ) ‖}^{2}}{\int exp - \frac{1}{2} {\sum }_{i = 1}^{N} {‖ {f}_{i} ( y ) ‖}^{2} dy} \qquad ( 7 )$$

In some cases, the equation above can be viewed as a continuous counterpart of the SoftMax function.

Reconstruction model 1000 is an example of, or includes aspects of, the corresponding element described with reference to FIGS. 7-9. Input views 1005 is an example of, or includes aspects of, the corresponding element described with reference to FIGS. 5 and 9. Image encoder 1010 is an example of, or includes aspects of, the corresponding element described with reference to FIGS. 7, 9, and 11. 2D image features 1015 is an example of, or includes aspects of, the corresponding element described with reference to FIG. 9.

3D position embeddings 1045 is an example of, or includes aspects of, the corresponding element described with reference to FIG. 9. 2D-to-3D transformer 1050 is an example of, or includes aspects of, the corresponding element described with reference to FIGS. 7 and 9. 3D features 1065 is an example of, or includes aspects of, the corresponding element described with reference to FIG. 9.

Triplane component 1070 is an example of, or includes aspects of, the corresponding element described with reference to FIGS. 7 and 9. Triplane features 1075 is an example of, or includes aspects of, the corresponding element described with reference to FIG. 9. Rendering component 1080 is an example of, or includes aspects of, the corresponding element described with reference to FIG. 9.

3D model 1082 is an example of, or includes aspects of, the corresponding element described with reference to FIGS. 3-5, 8, and 9. Pose model 1086 is an example of, or includes aspects of, the corresponding element described with reference to FIG. 7. Pose information 1088 is an example of, or includes aspects of, the corresponding element described with reference to FIG. 5.

FIG. 11 shows an example of an image generation model according to aspects of the present disclosure. The example shown includes diffusion model 1100, original image 1105, pixel space 1110, image encoder 1115, original image feature 1120, latent space 1125, forward diffusion process 1130, noisy feature 1135, reverse diffusion process 1140, denoised image feature 1145, image decoder 1150, output image 1155, text prompt 1160, text encoder 1165, guidance feature 1170, and guidance space 1175.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 1100 may take an original image 1105 in a pixel space 1110 as input and apply an image encoder 1115 to convert original image 1105 into original image feature 1120 in a latent space 1125. Then, a forward diffusion process 1130 gradually adds noise to the original image feature 1120 to obtain noisy feature 1135 (also in latent space 1125) at various noise levels.

Next, a reverse diffusion process 1140 (e.g., a U-Net ANN) gradually removes the noise from the noisy feature 1135 at the various noise levels to obtain the denoised image feature 1145 in latent space 1125. In some examples, denoised image feature 1145 is compared to the original image feature 1120 at each of the various noise levels, and parameters of the reverse diffusion process 1140 of the diffusion model are updated based on the comparison. Finally, an image decoder 1150 decodes the denoised image feature 1145 to obtain an output image 1155 in pixel space 1110. In some cases, an output image 1155 is created at each of the various noise levels. The output image 1155 can be compared to the original image 1105 to train the reverse diffusion process 1140. In some cases, output image 1155 refers to the synthetic image (e.g., described with reference to FIG. 4).

In some cases, image encoder 1115 and image decoder 1150 are pre-trained prior to training the reverse diffusion process 1140. In some examples, image encoder 1115 and image decoder 1150 are trained jointly, or the image encoder 1115 and image decoder 1150 are fine-tuned jointly with the reverse diffusion process 1140.

The reverse diffusion process 1140 can also be guided based on a text prompt 1160, or another guidance prompt, such as an image, a layout, a style, a color, a segmentation map, etc. The text prompt 1160 can be encoded using a text encoder 1165 (e.g., a multimodal encoder) to obtain guidance feature 1170 in guidance space 1175. The guidance feature 1170 can be combined with the noisy features 1135 at one or more layers of the reverse diffusion process 1140 to ensure that the output image 1155 includes content described by the text prompt 1160. For example, guidance feature 1170 can be combined with the noisy feature 1135 using a cross-attention block within the reverse diffusion process 1140.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 1160) describing content to be included in a generated image. In some examples, guidance can be provided in a form other than text, such as via an image, a sketch, a color, a style, or a layout. The system converts text prompt 1160 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 1100 generates an image based on the noise map and the conditional guidance vector.

A diffusion process can include both a forward diffusion process 1130 for adding noise to an image (e.g., original image 1105) or features (e.g., original image feature 1120) in a latent space 1125 and a reverse diffusion process 1140 for denoising the images (or features) to obtain a denoised image (e.g., output image 1155). The forward diffusion process 1130 can be represented as q(xₜ|xₜ₋₁), and the reverse diffusion process 1140 can be represented as p(xₜ₋₁|xₜ). In some cases, the forward diffusion process 1130 is used during training to generate images with successively greater noise, and a neural network is trained to perform the reverse diffusion process 1140 (e.g., to successively remove the noise).

In an example forward diffusion process 1130 for a latent diffusion model (e.g., diffusion model 1100), the diffusion model 1100 maps an observed variable x₀ (either in a pixel space 1110 or a latent space 1125) intermediate variables x₁, . . . , x_{T} using a Markov chain. The Markov chain gradually adds Gaussian noise to the data to obtain the approximate posterior q x_{1:T}|x₀) as the latent variables are passed through a neural network such as a U-Net, where x₁, . . . , X_{T} have the same dimensionality as x₀.

The neural network may be trained to perform the reverse diffusion process 1140. During the reverse diffusion process 1140, the diffusion model 1100 begins with noisy data X_{T}, such as a noisy image and denoises the data to obtain the p(xₜ₋₁|xₜ). At each step t−1, the reverse diffusion process 1140 takes xₜ, such as the first intermediate image, and t as input. Here, t represents a step in the sequence of transitions associated with different noise levels, The reverse diffusion process 1140 outputs xₜ₋₁, such as the second intermediate image iteratively until x_{T} is reverted back to x₀, the original image 1105. The reverse diffusion process 1140 can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 8 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 9 )$$

where p(x_{T})=N(x_{T}; 0, I) is the pure noise distribution as the reverse diffusion process 1140 takes the outcome of the forward diffusion process 1130, a sample of pure noise, as input and Πₜ₌₁^{T} p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space 1125 as input and a generated data % is mapped back into the pixel space 1110 from the latent space 1125 as output. In some examples, x₀ represents an original input image with low image quality, latent variables x₁, . . . , x_{T} represent noisy images, and \tilde{x} represents the generated image with high image quality.

A diffusion model 1100 may be trained using both a forward diffusion process 1130 and a reverse diffusion process 1140. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 1130 in N stages. In some cases, the forward diffusion process 1130 is a fixed process where Gaussian noise is successively added to an image. In latent diffusion models, the Gaussian noise may be successively added to features (e.g., original image feature 1120) in a latent space 1125.

At each stage n, starting with stage N, a reverse diffusion process 1140 is used to predict the image or image features at stage n−1. For example, the reverse diffusion process 1140 can predict the noise that was added by the forward diffusion process 1130, and the predicted noise can be removed from the image to obtain the predicted image. In some cases, an original image 1105 is predicted at each stage of the training process.

The training component (e.g., training component described with reference to FIG. 6) compares predicted image (or image features) at stage n−1 to an actual image (or image features), such as the image at stage n−1 or the original input image. For example, given observed data x, the diffusion model 1100 may be trained to minimize the variational upper bound of the negative log-likelihood −log p_{θ}(x) of the training data. The training component then updates parameters of the diffusion model 1100 based on the comparison. For example, parameters of a U-Net may be updated using gradient descent. Time-dependent parameters of the Gaussian transitions can also be learned.

Image encoder 1115 is an example of, or includes aspects of, the corresponding element described with reference to FIGS. 7, 9, and 10. Text prompt 1160 is an example of, or includes aspects of, the corresponding element described with reference to FIGS. 3 and 8.

### Training and Evaluation

In FIGS. 12-13, a method, apparatus, non-transitory computer readable medium, and system for 3D model generation include obtaining a training set including a plurality of training images depicting different views of a scene, initializing a 2D-to-3D transformer, and training, using the training set, the 2D-to-3D transformer to generate 3D features based on based on a plurality of 2D features and a set of 3D position embeddings, where the plurality of 2D features corresponds to a plurality of input images.

Some examples of the method, apparatus, non-transitory computer readable medium, and system further include generating an output image based on the 3D features. Some examples further include computing a reconstruction loss based on the output image and a training image from the plurality of training images. Some examples of the method, apparatus, non-transitory computer readable medium, and system further include computing a perceptual loss based on the output image and the training image.

Some examples of the method, apparatus, non-transitory computer readable medium, and system further include generating pose information for a training image from the plurality of training images. Some examples further include computing a pose loss based on the pose information.

Some examples of the method, apparatus, non-transitory computer readable medium, and system further include generating a 3D model based on the 3D features. Some examples further include computing a 3D model loss based on the 3D model and a ground-truth 3D model of an object. Some examples of the method, apparatus, non-transitory computer readable medium, and system further include training an image generation model to generate the plurality of input images based on a text prompt.

FIG. 12 shows an example of a method 1200 for training a 2D-to-3D transformer according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system obtains a training set including a set of training images depicting different views of a scene. In some cases, the operations of this step refer to, or may be performed by, a training component as described with reference to FIG. 7.

The machine learning model is trained on multi-view renderings of a large-scale 3D dataset. Different from the first stage that performs data curation, all of the 3D data in the dataset are used and are scaled to [−1, 1]³. Then, the machine learning model generates multi-view renderings based on the scaled data using Blender under uniform lighting with a resolution of 512×512. During inference, the input to the reconstruction model is generated in a structured setup with fixed camera poses, and the machine learning model is trained using random views as a data augmentation mechanism to increase the robustness. For example, for each object, the machine learning model randomly samples 32 views around the object at a set distance. During training, a subset of 8 images are randomly selected and 4 of these images are used as input and the remaining as novel views to provide supervision

In some cases, the machine learning model is trained using an Objaverse dataset, which comprises a set of objects. From the dataset, the machine learning model selects a group of objects for the training set. Instead of utilizing the direct 3D model, the machine learning model renders a plurality of views for each object at varying distances from its center, using the multi-view images to train the machine learning model.

At operation 1210, the system initializes a 2D-to-3D transformer. In some cases, the operations of this step refer to, or may be performed by, a training component as described with reference to FIG. 7. In some cases, initialization involves setting up the network architecture of the 2D-to-3D transformer to convert 2D images into triplane representations. In some cases, the triplane representations captures the 3D spatial features of the object depicted from the input image, the input views, the text prompt, or a combination thereof. In some cases, during the initialization process, the network layers are identified, parameters of the network layers are set, and the input-output mappings are configured.

At operation 1215, the system trains, using the training set, the 2D-to-3D transformer to generate 3D features based on based on a set of 2D features and a set of 3D position embeddings, where the set of 2D features corresponds to a set of input images. In some cases, the operations of this step refer to, or may be performed by, a training component as described with reference to FIG. 7. In some cases, a learning rate of 4×10⁻⁴ with a linear war up (on the first 3K steps) and a cosine decay is used to train the system. In some cases, the hyperparameter β₂ is set to 0.95 and the weight-decay of 0.05 for non-bias and non-layer norm parameters.

In some cases, the image encoder is initialized using DINO pre-trained weights. In some cases, the 2D-to-3D transformer and the triplane component, the default initializer in the Pytorch is used. In some cases, the positional embeddings (e.g., the 3D position embeddings described with reference to FIGS. 9 and 10) are initialized with Gaussian of zero-mean and std of 1/√1024.

In some cases, for each training step, four views are randomly sampled as input and another four views are selected as supervision without replacement. In some cases, the number of sample points per ray in NeRF rendering (e.g., the rendering component described with reference to FIGS. 9 and 10) is 128, which are uniformly distributed along the segment within the [−1,1]³ bounding box. The rendering resolution is 128×128. In some cases, the system is trained for 120 epochs with a training batch size of 1024.

FIG. 13 shows an example of a method 1300 for fine-tuning a 2D-to-3D transformer according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system computes a reconstruction loss based on an output image and a training image from a training set. In some cases, the operations of this step refer to, or may be performed by, a training component as described with reference to FIG. 7. In some cases, the reconstruction loss includes a mean squared error (MSE) loss, where the MSE loss measures the average difference between corresponding pixels of the output image and the training image. In some cases, the reconstruction loss includes a mean absolute error (MAE) loss, where the MAE loss measures the average absolute difference between the corresponding pixels of the output image and the training image.

At operation 1310, the system computes a perceptual loss based on the output image and the training image. In some cases, the operations of this step refer to, or may be performed by, a training component as described with reference to FIG. 7. In some cases, the perceptual loss measures the difference between high-level feature representations of the images extracted from a pre-trained network. Perceptual loss leverages feature maps from intermediate layers of a pre-trained network, capturing complex structures and textures. For example, the perceptual loss can be calculated as:

$${L}_{perceptual} = {\sum }_{l} {‖ {∅}_{l} ( y ) - {∅}_{l} ( \hat{y} ) ‖}_{2}^{2} \qquad ( 10 )$$

where Øₗ(y) and Øₗ (y) are the feature representations of the target and generated images at layer l, respectively.

At operation 1315, the system computes a pose loss based on the pose information for the training image. In some cases, the operations of this step refer to, or may be performed by, a training component as described with reference to FIG. 7. In some cases, the machine learning model uses a MLP to predict a surface point for each patch token output by the transformer. The predicted surface point is supervised to align with volume-rendered surface point from the predicted triplane NeRF corresponding to the ray of the patch center pixel. To account for nonobject patch centers, the machine learning model uses the accumulated transmittance to weigh the per-patch point loss.

In some cases, the per-patch predicted points establish a set of 3D-2D correspondences for each view, where for each patch, the predicted 3D point corresponds to the center pixel of the patch. In some cases, a differentiable PnP solver is used to obtain the camera poses, and the differentiable PnP solver compares the camera poses against ground-truth poses.

At operation 1320, the system computes a 3D model loss based on a generated 3D model and a ground-truth 3D model of an object. In some cases, the operations of this step refer to, or may be performed by, a training component as described with reference to FIG. 7. In some cases, to supervise the predicted triplane renderings, the machine learning model renders multiple viewpoints using the ground-truth camera poses, and then computes image reconstruction losses, including L2 loss and LPIPS loss between the renderings and ground-truth images.

During training, the machine learning model uses a KL divergence loss between the posterior pose density p (y|X) and the target pose probability density t(y):

$${L}_{KL} ( t ( y ) ‖ p ( y \vert X ) ) = - \int t ( y ) log p ( X \vert y ) dy + log \int p ( X \vert y ) dy , \qquad ( 11 )$$

which can be further simplified assuming Dirac delta target distribution centered at the ground truth y_{gt}, and estimated as:

$${L}_{KL} = \frac{1}{2} {\sum }_{i = 1}^{N} {‖ {f}_{i} ( {y}_{gt} ) ‖}^{2} + log \int exp ( - \frac{1}{2} {\sum }_{i = 1}^{N} {‖ {f}_{i} ( y ) ‖}^{2} ) dy . \qquad ( 12 )$$

which the first portion of the equation above represents L_{tgt} (reprojection error at target pose), and the second portion of equation above represents L_{pred} (reprojection error at predicted pose).

### Computing Device

FIG. 14 shows an example of a computing device 1400 according to aspects of the present disclosure. The example shown includes computing device 1400, processor 1405, memory subsystem 1410, communication interface 1415, I/O interface 1420, user interface component 1425, and channel 1430.

In some embodiments, computing device 1400 is an example of, or includes aspects of, the image processing apparatus described with reference to FIGS. 1 and 7. In some embodiments, computing device 1400 includes processor 1405 that can execute instructions stored in memory subsystem 1410 to obtain a plurality of input images depicting an object and a set of 3D position embeddings, encode the plurality of input images to obtain a plurality of 2D features corresponding to the plurality of input images, respectively, generate 3D features based on the plurality of 2D features and the set of 3D position embeddings, ang generate a 3D model of the object based on the 3D features.

According to some embodiments, processor 1405 includes one or more processors. In some cases, processor 1405 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1405 is configured to operate a memory array using a memory controller. In other cases, a memory controller is integrated into processor 1405. In some cases, processor 1405 is configured to execute computer-readable instructions stored in a memory to perform various functions. In some embodiments, processor 1405 includes special-purpose components for modem processing, baseband processing, digital signal processing, or transmission processing. Processor 1405 is an example of, or includes aspects of, the processor unit described with reference to FIG. 7.

According to some embodiments, memory subsystem 1410 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1410 is an example of, or includes aspects of, the memory unit described with reference to FIG. 7.

According to some embodiments, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1415.

According to some embodiments, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or hardware components controlled by the I/O controller. I/O interface 1420 is an example of, or includes aspects of, the I/O module described with reference to FIG. 7.

According to some embodiments, user interface component 1425 enables a user to interact with computing device 1400. In some cases, user interface component 1425 includes an audio device, such as an external speaker system, an external display device such as a display screen, an input device (e.g., a remote-control device interfaced with a user interface directly or through the I/O controller), or a combination thereof. User interface component 1425 is an example of, or includes aspects of, the user interface described with reference to FIG. 7.

The performance of apparatus, systems, and methods of the present disclosure have been evaluated, and results indicate embodiments of the present disclosure have obtained increased performance over existing technology (e.g., 3D model generators). Example experiments demonstrate that the 3D model generation apparatus based on the present disclosure outperforms conventional models. Details on the example use cases based on embodiments of the present disclosure are described with reference to FIGS. 3-5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a plurality of input images depicting an object and a set of 3D position embeddings, wherein each of the plurality of input images depicts the object from a different perspective;
encoding the plurality of input images to obtain a plurality of 2D features corresponding to the plurality of input images, respectively;
generating, using a 2D-to-3D transformer, 3D features based on the plurality of 2D features and the set of 3D position embeddings; and
generating a 3D model of the object based on the 3D features.

2. The method of claim 1, wherein generating the 3D features comprises:
performing an attention mechanism on the plurality of 2D features and the set of 3D position embeddings.

3. The method of claim 1, further comprising:
generating triplane features based on the 3D features, wherein the 3D model is generated based on the triplane features.

4. The method of claim 1, further comprising:
generating an output image based on the 3D model, wherein the output image depicts the object from a perspective different from the plurality of input images.

5. The method of claim 1, further comprising:
obtaining view information for each of the plurality of input images, wherein the plurality of input images are encoded based on the view information.

6. The method of claim 1, wherein obtaining the plurality of input images comprises:
obtaining an input prompt describing the object; and
generating the plurality of input images based on the input prompt.

7. The method of claim 1, further comprising:
obtaining a reference view encoding for a first image of the plurality of input images and a source view encoding for a second image of the plurality of input images, wherein the first image is encoded based on the reference view encoding and the second image is encoded based on the source view encoding.

8. The method of claim 1, further comprising:
obtaining view intrinsic parameters of each of the plurality of input images, wherein the plurality of input images are encoded based on the view intrinsic parameters.

9. The method of claim 1, further comprising:
generating, using the 2D-to-3D transformer, a plurality of image-specific output features corresponding to the plurality of input images, respectively; and
generating pose information for each of the plurality of input images based on the plurality of image-specific output features.

10. The method of claim 1, wherein:
the 2D-to-3D transformer is trained using a training set that includes a plurality of training images depicting different views of a scene.

11. A method comprising:
obtaining a training set including a plurality of training images depicting different views of a scene;
initializing a 2D-to-3D transformer; and
training, using the training set, the 2D-to-3D transformer to generate 3D features based on based on a plurality of 2D features and a set of 3D position embeddings, wherein the plurality of 2D features corresponds to a plurality of input images.

12. The method of claim 11, wherein training the 2D-to-3D transformer comprises:
generating an output image based on the 3D features; and
computing a reconstruction loss based on the output image and a training image from the plurality of training images.

13. The method of claim 12, wherein training the 2D-to-3D transformer comprises:
computing a perceptual loss based on the output image and the training image.

14. The method of claim 11, wherein training the 2D-to-3D transformer comprises:
generating pose information for a training image from the plurality of training images; and
computing a pose loss based on the pose information.

15. The method of claim 11, wherein training the 2D-to-3D transformer comprises:
generating a 3D model based on the 3D features; and
computing a 3D model loss based on the 3D model and a ground-truth 3D model of an object.

16. The method of claim 11, further comprising:
training an image generation model to generate the plurality of input images based on a text prompt.

17. A system comprising:
a memory component; and
a processing device coupled to the memory component, the processing device configured to perform operations comprising:
obtaining a plurality of input images depicting an object and a set of 3D position embeddings, wherein each of the plurality of input images depicts the object from a different perspective;
encoding the plurality of input images to obtain a plurality of 2D features corresponding to the plurality of input images, respectively;
generating, using a 2D-to-3D transformer, 3D features based on the plurality of 2D features and the set of 3D position embeddings; and
generating a 3D model of the object based on the 3D features.

18. The system of claim 17, wherein:
the 2D-to-3D transformer comprises a cross-attention layer and a self-attention layer.

19. The system of claim 17, further comprising:
a triplane component configured to generating triplane features based on the 3D features.

20. The system of claim 17, further comprising:
a pose model trained to generate pose information for each of the plurality of input images.
